(19) United States
(12) Patent Application Publication
(10) Pub. No.: US 2013/0306555 A1
(43) Pub. Date: Nov. 21, 2013

(54) MATERIALS AND METHODS FOR ENVIRONMENTAL CONTAMINANT REMEDIATION

(71) Applicant: TETRA TECH, INC., Pasadena, CA (US)

(72) Inventor: Sandip Chattopadhyay, Mason, OH (US)

(73) Assignee: TETRA TECH, INC., Pasadena, CA (US)

(21) Appl. No.: 13/742,482

(22) Filed: Jan. 16, 2013

Related U.S. Application Data
(60) Provisional application No. 61/646,993, filed on May 15, 2012.

(51) Int. Cl. C02F 3/10

(52) U.S. Cl. CPC C02F 3/104
USPC 210/616; 210/660; 210/691; 252/176; 427/215

(57) ABSTRACT

An anthropogenic sorbent material modified for sequestering and/or attenuating multiple chemical and/or biological pollutant species, both organic and inorganic, in an aqueous environment is disclosed as well as a method of sequestering and/or attenuating multiple chemical and/or biological pollutant species, both organic and inorganic, in an aquatic ecosystem by capping at least a portion of a sedimentary basin of the aquatic ecosystem.

### PRIORITY

This application claims priority to U.S. provisional application Ser. No. 61/646,993 filed on May 15, 2012, and entitled “MATERIALS AND METHODS FOR ENVIRONMENTAL CONTAMINANT REMEDIATION” to Sandip Chattopadhyay, the entirety of which is incorporated herein by reference.

### FIELD

This disclosure relates to the field of pollutant remediation and sequestration technology. More particularly, this disclosure relates to a unique material and method for remediating pollutants in aqueous, soil, and sediment environments.

### BACKGROUND

Cost effective and performance efficient remediation of contaminants from water, soil, sediment, and air systems is playing an ever-increasing important role in maintaining sustainability and providing unique and value-added support to clients. Conventional cleanup technologies address contamination/pollution; however, many such additive materials (sorbents) and methods may create auxiliary problems and these side effects are undesirable. Such undesirable effects might include release (leaching) of the weakly bound contaminants as time progresses or release by competitive substitution of new contaminants due to the change in environmental conditions. In many cases, the various types of contaminants necessitate the need to employ sustainable and environmentally friendly remediation technology that can provide irreversible sequestration of contaminants and their byproducts and that can be cost effective.

What is needed, therefore, are materials and methods to remediate water contamination while minimizing undesirable side effects.

### SUMMARY

A unique porous aluminosilicate bonded ceramic is disclosed that has a high porosity and high surface area. The inter-connected porosity (macro-, meso-, and micro-pores) of a base structure provides a high surface area for reactive chemical ingredient(s) for abiotic remediation and/or the formation of biofilms that house beneficial microorganisms (bacteria or other species) for bioremediation. The surface of this porous base is engineered to provide desired functionality by one or more surface modifications. The surface modifications can be conducted by using nonionic, anionic, or zwitterionic organic/inorganic surface functional groups (including surfactants), and/or micro-, or nano-sized minerals, inorganic reactive compounds, and/or impregnating the macroporous material with biological materials. This material provides a cost effective solution to remediate and manage contaminated sediments by providing extensive suitability to a wide range of contaminants, and minimal/low adverse environmental effects.

A reactive (or active) capping technology using this multifunctional engineered porous material has been designed and developed to remediate (both chemically and/or biologically) targeted contaminants (inorganic and organic) in the sediment-water systems. This cap material is not only capable of remediating the contaminants but also provides a solution to gas ebullition due to its high permeable layer. Compared with most other sediment cap materials, the material disclosed herein has the following unique properties compared to the other reactive (or active) cap materials that are commercially or naturally available:
has particle size ranging from gravel size to colloidal size to have large surface sites available for reactions
has optimum bulk density so that this material can sink quickly in the majority of site-specific water column and mostly remain on the top of native sediment (the remaining portion present as mixed layer with sediment)
has high sorption capacity to sequester various types of contaminants
has high permeability due to its porous structure
allows high flow of upwelling water and biogenic gas
sequesters more contaminant per unit weight
works faster due to higher reaction kinetics—less contact time is required (minutes vs. hours)
has long life for most applications.

High surface area with appropriate surface functional moieties provides more surface active sites resulting in faster sorption kinetics (8 to 18 hours) and higher sorption capacities for variety of contaminants compared to conventional materials. Due to the large amount of available surface area, the biofilms and bacterial buildup remains relatively thin thereby maintaining excellent permeability for water flowing through the material. Furthermore, the composition of the media can also be adjusted to accommodate electron acceptors/donors/slow releasing nutrients/buffering agents to promote oxidation/reduction reactions within a controlled environmental regime, if needed.

Typical contaminants that can be targeted include polycyclic aromatic hydrocarbons (PAHs), polychlorinated biphenyls (PCBs), heavy metals and metalloids (mercury, copper, selenium, arsenic, etc.) and other organic and inorganic compounds.

This material can be manufactured/synthesized in a variety of shapes and sizes, and impregnated with manganese dioxide, iron oxides/hydroxides/oxyhydroxides, and other reactive chemical compounds and biological species that are reactive for site-specific contaminants and not harmful for the native benthic community. This characteristic provides flexibility for many applications and for different types of soil- and sediment-water bodies. The material can be applied in the sediment-water interface as solid form, slurry (mixed with site water), or mat. A mat can be filled with this reactive material and can provide additional benefits of stability, defined mass per area, and reduce biointrusion. Application of these materials also allows smaller amount of material and smaller size of applicators that is cost-effective due to considerable reduction in carbon and environmental footprint.

An anthropogenic sorbent material modified for sequestering and/or attenuating multiple chemical and/or biological pollutant species, both organic and inorganic, in an aqueous environment is disclosed. The modified sorbent material comprises a plurality of aluminosilicate particles, each particle having a particle size ranging from about 32×10⁻³ meters to about 3.9×10⁻⁶ meters based on the Krumbein phi scale wherein −5≦φ<8, wherein each particle further comprises a plurality of substantially interconnected pore spaces including micro-, meso-, and macro-porous spaces; one or more reactive chemical and/or microbiological species impregnated in some of the plurality of macro-porous pore spaces; and one or more functional moieties applied to at least a portion of the outer surfaces of at least a portion of the particles. Each aluminosilicate particle may include a particle size ranging from about 32×10⁻³ meters to about 2×10⁻³ meters based on the Krumbein phi scale wherein −5≦φ≦−1. Alternatively, each aluminosilicate particle may have a particle size ranging from about 2×10⁻³ meters to about 3.9×10⁻⁶ meters based on the Krumbein phi scale wherein −1≦φ<8. The reactive chemical may further comprise an iron oxide, magnesium oxide, manganese dioxide, iron hydroxide, iron oxyhydroxide, or one or more combinations thereof.

A method of preparing an anthropogenic sorbent material modified for sequestering and/or attenuating multiple chemical and/or biological pollutant species, both organic and inorganic, in an aqueous environment is also disclosed. The method comprises the steps of (a) dividing an aluminosilicate base into a plurality of aluminosilicate particles, each particle having a particle ranging from about 32×10⁻³ meters to about 3.9×10⁻⁶ meters based on the Krumbein phi scale wherein −5≦φ<8, wherein each particle further comprises a plurality of substantially interconnected pore spaces including micro-porous spaces, meso-porous spaces, and macro-porous spaces; (b) impregnating some of the plurality of macro-porous pore spaces with one or more reactive chemical and/or microbiological species; (c) applying one or more functional moieties to at least a portion of the outer surfaces of at least a portion of the particles.

A method of sequestering and/or attenuating multiple chemical and/or biological pollutant species, both organic and inorganic, in an aquatic ecosystem by capping at least a portion of a sedimentary basin of the aquatic ecosystem is also disclosed. The method comprises the steps of: a) preparing an anthropogenic sorbent material comprising a plurality of aluminosilicate particles, each particle having a particle size ranging from about 32×10⁻³ meters to about 3.9×10⁻⁶ meters based on the Krumbein phi scale wherein −5≦φ<8, wherein each particle further comprises a plurality of substantially interconnected pore spaces including micro-porous spaces, meso-porous spaces, and macro-porous spaces; and b) applying the anthropogenic sorbent material to at least a portion of the sedimentary basin of the aquatic ecosystem. Step a) may further comprise the substep a)(1) of determining one or more conditions at the sedimentary basin including the type or types of pollutants to be treated in the aquatic ecosystem. Step a) may further comprise the substep a)(2) of impregnating some of the plurality of macro-porous pore spaces in the aluminosilicate particles with one or more microbiological species that react to interact and/or sequester at least some of the type or types of pollutants to be treated in the aquatic ecosystem. Alternatively, step a) may further comprise the substep a)(2)′ of applying one or more functional moieties to at least a portion of the outer surfaces of at least a portion of the particles wherein the applied functional moieties are selected based on their reactivity to attenuate and/or sequester at least some of the type or types of pollutants to be treated in the aquatic ecosystem.

Step a) may further comprise the substep a)(3) of applying one or more functional moieties to at least a portion of the outer surfaces of at least a portion of the particles wherein the applied functional moieties are selected based on their reactivity to attenuate and/or sequester at least some of the type or types of pollutants to be treated in the aquatic ecosystem.

Step b) may further comprise the substeps of: b)(1) mixing the particles of the anthropogenic sorbent material into an aqueous slurry; and b)(2) pumping the slurry to a location proximate a surface of the sedimentary basin to cover at least a portion of the surface of the sedimentary basin with the particles of the anthropogenic sorbent material. Alternatively, substep b) (1) includes applying the particles of the anthropogenic sorbent material in solid form, preferably applying the solid to a location proximate a surface of the sedimentary basin to cover at least a portion of the surface of the sedimentary basin with the particles of the anthropogenic sorbent material.

Step a)(1) may further comprise determining the quantity or quantities of pollutants to be treated in the aquatic ecosystem.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIGS. 1A and 1B are graphs showing surface water quality parameters for water collected from a typical metal-contaminated site;

FIG. 2 is a graph showing the physical characteristics of the porous aluminosilicates and other naturally available and commercially available capping materials tested;

FIGS. 3 and 4 are graphs plotting the sorption of isotherms of Cu and As with respect to an increase in the equilibrium concentrations of Cu and As on the grab sediments collected from a metal contaminated site;

FIGS. 5 and 6 are graphs showing the sorption isotherms for the cap materials tested;

FIG. 7 is a graph showing the total concentration of target analyte list (TAL) metals present in the tested cap materials;

FIG. 8 is a graph showing a comparison of select metals in the deionized water Waste Extraction Test (DI-WET) leachate and the water quality screening criteria;

FIG. 9 illustrates a method of determining the settling velocity of sediment;

FIG. 10 depicts the settling of cap material through water column under a laboratory setting;

FIG. 11 shows a settled consolidated cap material on top of native sediment 10 days after deployment;

FIGS. 12 and 13 are graphs showing the settling velocities, particle sizes under flow conditions of the tested cap materials (the Reynolds number is a dimensionless number that gives a measure of the ratio of forces and quantifies the relative importance of these forces for given flow conditions).

FIG. 14 is a close-up schematic view of various mechanisms of sequestration of contaminants on a capping material according to one embodiment of the present disclosure;

FIG. 15 shows an apparatus for applying a capping material according to one embodiment of the present disclosure;

FIG. 16 shows an apparatus including a mat for applying a capping material according to one embodiment of the present disclosure;

FIG. 17 is an X-ray diffraction graph showing raw data for an untreated sample crushed using a commercially available untreated organoctay (AquaGate) material superimposed with an organoclay sample treated with 5000 mg/L (ppm) of Cu salt;

FIG. 18 is an X-ray diffraction graph showing raw data for an untreated sample of a commercially available material (fishbone or apatite superimposed with the same material treated with an initial aqueous concentration of 5000 ppm Cu and As salts;

FIG. 19 is an X-ray diffraction graph showing raw data for an untreated sample of porous aluminosilicate (MAC-4), superimposed with the same material treated with an initial aqueous concentration of 5000 ppm As and Cu;

FIG. 20 is an X-ray diffraction graph showing raw data for an untreated sample of Bay Mud (MB-4), superimposed with raw data for a sample of MB-4 treated with an initial aqueous concentration of 5000 ppm As and Cu;

FIG. 21 is an X-ray diffraction graph showing raw data for untreated phosphate rock (PR-4);

FIG. 22 is a graph of background subtracted scan of untreated AGC-4 with selected d-I pattern overlays;

FIG. 23 is a graph of background subtracted scans of both untreated AGC-4 and AGC-4 treated with ethylene glycol solvated, with selected d-I pattern overlays;

FIG. 24 is a graph of a background subtracted scan of AGC-4 treated with an initial aqueous concentration of 5000 ppm Cu, with selected d-I pattern overlays:

FIG. 25 is a graph of a background subtracted scan of untreated AP2-4 with selected d-I pattern overlays;

FIG. 26 is a graph of a background subtracted scan of AP2-4 treated with an initial concentration of 5000 ppm As, with selected d-I pattern overlays;

FIG. 27 is a graph of a background subtracted scan of AP2-4 treated with an initial concentration of 5000 ppm Cu, with selected d-I pattern overlays;

FIG. 28 is a graph of background subtracted scan of untreated MAC-4 with selected d-I pattern overlays;

FIG. 29 is a graph of a background subtracted scan of MAC-4 treated with an initial aqueous concentration of 5000 As, with selected d-I pattern overlays:

FIG. 30 is a graph of a background subtracted scan of MAC-4 treated with an initial aqueous concentration of 5000 ppm of Cu, with selected d-I pattern overlays;

FIG. 31 is a background subtracted scan of untreated MB-4 with selected d-I pattern overlays;

FIG. 32 is a graph of background subtracted scans of both untreated MB-4 and MB-4 treated with ethylene glycol solvated, with selected d-I pattern overlays:

FIG. 33 is a graph of background subtracted scans of MB-4 treated with an initial aqueous concentration of 5000 ppm As, with selected d-I pattern overlays;

FIG. 34 is a graph of a background subtracted scan of MB-4 initially treated with an aqueous concentration of 5000 ppm, with selected d-I pattern overlays; and

FIG. 35 is a graph of a background subtracted scan of untreated PR-4 with selected d-I pattern overlays.

### DETAILED DESCRIPTION

The first portion of the detailed description herein includes information from treatability testing conducted on various materials including the material claimed herein to compare various important characteristics of such materials. This information includes data from such tests that were conducted for a typical contaminated sediment site in 2011.

### Section 1: Introduction

### 1.1 Background

Capping refers to the process of placing a sub-aqueous covering or proper isolating materials to cover and separate the contaminated sediments from the water column. An effective cap can reduce contamination risk by: a) physical isolation of the contaminated sediment from the aquatic environment, b) stabilization/erosion protection of contaminated sediment, and c) chemical isolation/reduction of the movement of dissolved and colloidally transported contaminants into the water. Conventionally, a cap may be constructed of clean sediments, sand, gravel, natural/synthetic reactive material or may involve a more complex design with geotextiles, liners and multiple layers of a single material or multiple materials. A variation in caps could involve the removal of contaminated sediments to some depth, followed by capping the remaining sediments in-place. This is suitable where capping alone is not feasible because of hydraulic or navigational restrictions on the waterway depth. As capping is not a treatment process, long-term environmental effects, including possible remobilization of contaminated sediment, need to be carefully considered by regular monitoring of the capped system. However, there is a possibility that buried target contaminant(s) may pass through the capping layer and enter into the overlying water due to various reasons (hydrodynamic flows, consolidation, transformation, diffusion, leaching, bioturbation, etc.). Hydrodynamic currents caused by human activities or natural processes, such as shipping, tide, and groundwater flow may scour the capping layer and release contaminant into the water. The cost of cap material varies based on the type, purity, size, delivery, and other conditions.

### 1.2 Purpose of Testing

The objective of the treatability tests was to assess the effectiveness to provide long-term protection of the environment of an active material as reactive cap material and evaluate its performance with respect to other commercially- and naturally-available materials. A series of tests were conducted to achieve the objective of the treatability study to compare key physical and chemical characteristics of these materials and predict the long term performance of their environmental applications.

Four materials were selected to evaluate their effectiveness for long-term protection of human and ecological health and the environment, and for acquiring data to be used in the remedial design (RD) of the contaminated site. The four potential cap materials evaluated were:
Bay Mud from local borrow source;
Clay (composite-aggregate of gravel core coated with clay) from a commercial supplier (AquaBlok®);
Porous Aluminosilicate; and
Two types of phosphates—a) biogenic form from fishbone apatite, and a) mineral form as phosphate rock from commercial suppliers (PIMS NW, Inc. and Potash Corporation, respectively).

Sediment and surface water samples were collected from a representative contaminated site in California and were analyzed for physical and chemical characteristics. The surface water samples were analyzed for temperature (degree Celsius, ° C.), pH, conductivity (micro-Siemens per square centimeter, μS/cm²), oxidation-reduction potential (ORP) (milli-volts, mV), dissolved oxygen (DO) concentration (milli-grams per liter, mg/L), turbidity (Nephelometric Turbidity Unit, NTU), and total metals (arsenic [As], cadmium [Cd], copper [Cu], iron [Fe], lead [Pb], mercury [Hg], selenium [Se], and zinc [Zn]) concentrations (micrograms per liter, μg/L). Pore waters were extracted from the sediment samples. Sediment, pore water, and cap material samples were analyzed for eight metals concentrations as indicated before. In addition, the sediment samples were analyzed for the sorption capacity with respect to As and Cu. The cap materials were analyzed for the following tests:
Moisture content, specific gravity, grain size, total organic carbon (TOC) and X-ray diffraction;
Leachable metals, volatile organic carbons (VOCs) and semi-volatile carbons (SVOCs) to evaluate the potential for each material to leach heavy metals and organics;
Sorption tests to determine the metal sorption capacities (As and Cu) of each of the selected cap materials;
Desorption of various metals (aluminum [Al], antimony [Sb], As, barium [Ba], beryllium [Be], Cd, chromium [Cr], cobalt [Co], Cu, Fe, Pb, manganese [Mn], Hg, molybdenum [Mo], nickel [Ni], Se, silver [Ag], thallium [Tl], vanadium [Va], and Zn) from the contaminated sediment in presence of individual cap material; and
Settling velocities of selected cap materials in site water.

### 2. Samples Tested

Sediment and surface water samples from contaminated site and four types of materials were tested.

The sediment samples were collected from the locations historically containing high concentrations of contaminants (e.g., metals). In addition to capturing sediment texture (clay, sand, silt, organic composition) efforts were taken during field sampling not to dilute the metal concentrations with cleaner sediments. To minimize disturbance to the surface of the marsh and suspension of contaminated sediment in the ditches, and for greater accessibility, sediment samples were collected during low tide. Samples from one of the sites were collected with a trowel/shovel and bucket for physical analysis. The three sample locations from each site were composited in the field as a preliminary homogenization for physical analysis with a final homogenization in the respective laboratories. At another site location, the top 6 inches of sediment were collected from each of the composite sampling locations using a Ponar® grab sampler from a flat-bottomed boat on the slough, where accessible by boat. The sampler consisted of a pair of weighted, tapered jaws held open by a catch tension bar across the top of the sampler. The upper portion of the jaws was covered with a metal screen and a rubber flap, allowing water to pass through the sampler during descent, and reducing disturbance at the sediment-water interface. When the sampler touched the bottom of the slough, the tension rod was released and the jaws closed, collecting sediment.

Surface water was collected from one location of the respective sites as representative of background water quality (i.e., electrolyte concentrations, TOC content, and other parameters) using a bailer and tube into 2.5-gallon plastic containers. Efforts were taken to avoid pulling surface water from the bottoms of the ditches to minimize the amount of suspended materials in the sample. Field water quality parameters, including temperature, ORP, DO, pH, turbidity, and conductivity, at various depths were recorded while collecting the samples. The samples were shipped to the laboratories and stored in a controlled temperature room (4±2° C.) prior to the treatability tests.

The following paragraphs detail the four types of cap materials that were identified for possible use at the sites.
Bay Mud: An abundant supply of clay-rich local sediment was available from the prior dredging operations. This dredge spoil mud is stored in two large containment cells adjacent to the marina.
Organoclay: A commercially available pelletized composite material, AquaGate+™ (hereinafter referred to as AquaGate), was used. These types of cap materials are generally manufactured as composite aggregate technology producing materials resembling small pieces of gravel comprised of a central core (often stone aggregate) coated with patented clay or clay sized materials. The key clay component of the coated material is bentonite. These type of materials were procured as the following components:
   A formulation mix of composite aggregate;
   Gravel (central core unit); and
   Powdered patented AquaGate+Sorb™ containing 2.5% SORBSTER™.
The active key ingredient (powdered AquaGate) was used for testing the sorption and desorption capacities whereas the geotechnical analyses were conducted using the composite aggregate mix.

Porous Aluminosilicate:

In a preliminary testing, porous aluminosilicates containing active surface functional moieties have shown significant sorption of Cu in our bench-scale studies. The porous structure provides significantly large reactive surface sites; moreover, porous aluminosilicates have higher permeabilities than conventional cap materials. Higher permeability and high sorption capacity are desirable properties for an appropriate cap material. This aluminosilicate bonded ceramic typically has over 85% interconnected open porosity with much higher surface area than most other media. The surface area of the supporting structure depends on the composition and the processing conditions and varies between 2 to >350 m²/gm. This material can be synthesized in a variety of shapes and sizes ranging from granular to monoliths with desired bulk density to provide flexibility for specific applications. Granular size fraction of this material was selected for this series of screening tests for higher surface area and ease of application.

Apatite:

The apatite mineral structure conforms to the class of minerals with hexagonal crystal structure and the generic formula Me₅(XO₄)₃Z where Me is Ca, Sr, Ba, Cd, or Pb (typically), X═P, As, V, Mn, or Cr; and Z═OH, F, Cl, or Br. The apatite family includes the carbonate apatite, chlorapatite, fluorapatite, hydroxyapatite, and others. The mineral apatite can be available in sand to pebble sized rock phosphates. Apatites can react with heavy metals through both surface sorption reactions and precipitation reactions. Generally, divalent metals such as Cd, Cu, Ni, and Zn will undergo sorption to the hydroxyapatite surface at low metal cation concentrations, form solid solutions (e.g. (Me, Ca)₅(PO₄)₃OH) at concentrations around metal apatite saturation, and pure metal precipitates on the hydroxyapatite surface at concentrations above metal precipitate form under high carbonate concentrations. Apatites are geochemically stable as they are the most common diagenic product of sedimentary accretion of phosphate in marine sediments and are found in a range of sediment conditions including oxidized to moderately reducing (Eh=−270 mV). However, releases of bound As by competitive anions have been reported due to anion exchange. A variety of competitive anions (e.g. phosphate, bicarbonate, sulfate or silicate), due to its similar structure and chemical nature, can replace As from sorbent surface sites, phosphate can release As up to three orders of magnitude more than bicarbonate, sulfate or silicate. To evaluate whether the phosphates would not mobilize/desorb bound arsenate from this site-specific native sediment, desorption tests have been conducted with known quantities of potential cap materials to containers of site-specific composite sediment and surface water. Two types of apatite were procured for the treatability tests: a) Apatite II™ from PIMS-NW, Inc, Kennewick, Wash. and b) phosphate rock (32% bone phosphate of lime, BPL) from PotashCorp, Northbrook, Ill. The purity and mineralogical composition of these materials were not available from the supplier. X-ray diffractogram (XRD) of these materials provided additional structural information of these minerals used.

### 3. Test Results

### 3.1 Characteristics of Surface Water and Cap Materials

### 3.1.1 Test Procedure

Surface water quality parameters at various depths were monitored at site by handheld multi-parameter sondes YSI Quality Meter (Model 650 MDS). The water quality sonde simultaneously measured pH, temperature, dissolved oxygen, conductivity, turbidity, water depth, and oxidation reduction potential (ORP).

Cap materials were analyzed for the grain size, specific gravity, and moisture content. Grain size analysis was conducted using ASTM Method D422 (Standard Test Method for Particle-Size Analysis of Soils). This test method provided the quantitative determination of the distribution of particle sizes. The distribution of particle sizes larger than 75 micrometers (μm) (retained on the No. 200 sieve) was determined by sieving, while the distribution of particle sizes smaller than 75 μm was determined by a sedimentation process using a hydrometer. The specific gravities of cap materials were analyzed using ASTM method D 854m (Standard Test Methods for Specific Gravity of Soil Solids by Water Pycnometer). The moisture content of the cap materials were analyzed by ASTM method D2216 (Test Methods for Laboratory Determination of Water (Moisture) Content of Soil and Rock by Mass). Sieve analysis, hydrometer analysis, and hygroscopic moisture analysis were performed by standard laboratory equipment including balances, stirring apparatus, hydrometer, sedimentation cylinder, thermometer, sieves, water bath or constant-temperature room, beaker, and timing device on the sample materials as received.

### 3.1.2 Results

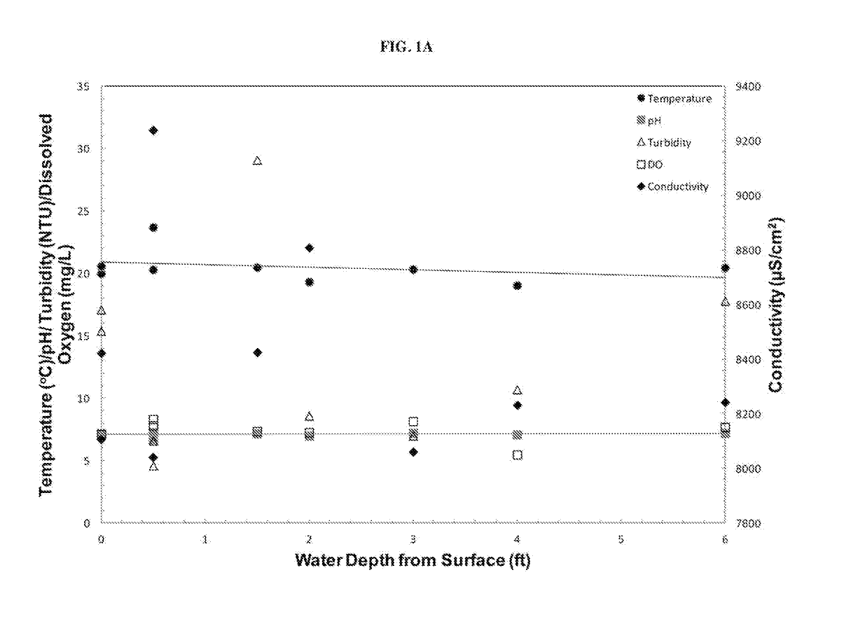

The water properties are shown in Table 3-1 and FIGS. 1A and 1B.

The temperature varied from 20° C. to 23.7° C. at the surface and 19.04° C. at 4-ft sediment-water interface to 20.46° C. at 6-ft sediment-water interface. The pH values varied between 6.7 to 7.26. The turbidity varied for various locations and depths ranging from 4.6 NTU to 29.1 NTU. The DO and ORP values correlated well at the various water depths (FIG. 1B). The conductivity varied from 8042 μS/cm² to 9239 μS/cm² indicating higher salinity due to seawater.

TABLE 3-1
Surface Water Quality Field Parameters

| | Temp | | Conductivity | ORP | DO | Turbidity |
|---|---|---|---|---|---|---|
| Depth | ° C. | pH | uS/cm² | mV | mg/L | NTU |
| 0.5 ft | 23.7 | 6.7 | 9239 | 276 | 8.32 | 6.6 |
| 2 ft | 19.33 | 7 | 8808 | 240.6 | 7.27 | 8.6 |
| 4 ft (sed-water | 19.04 | 7.09 | 8232 | 243.5 | 5.48 | 10.7 |
| interface) | | | | | | |
| surface | 20 | 7.15 | 8107 | 222.4 | 7.12 | 15.4 |
| surface | 20.58 | 7.19 | 8422 | 259.3 | 7.13 | 17.1 |
| 1.5 ft | 20.49 | 7.16 | 8425 | 255.4 | 7.36 | 29.1 |
| shallow | 20.31 | 7.26 | 8042 | 269.4 | 7.81 | 4.6 |
| 6 ft (sed-water | 20.46 | 7.21 | 8243 | 267 | 7.68 | 17.8 |
| interface) | | | | | | |
| 3 ft | 20.33 | 7.22 | 8061 | 264.8 | 8.16 | 7 |

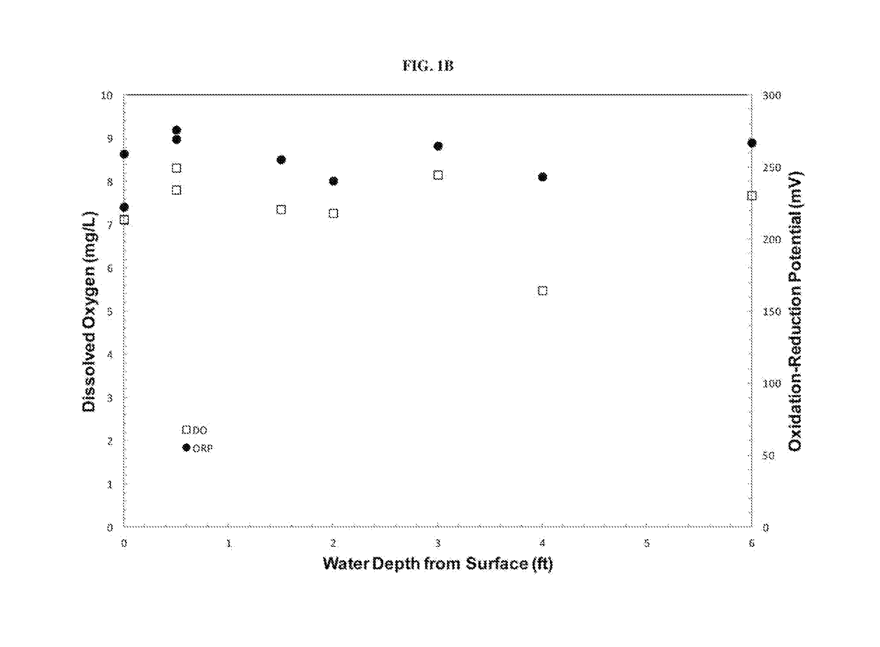

The physical characteristics of the cap materials after visual inspections and geotechnical analyses are shown in Table 3-2 and FIG. 2. The results of the mechanical analysis (sieve and hydrometer analyses) are shown as particle size distribution curves. The percent finer than a sieve size is calculated as follows:

Percent Finer than a Sieve Size=100%−Σ{(weight of solids retained/total solid weight)×100%}

Three basic parameters can be determined from the particle size distribution curves: a) effective size, b) uniformity coefficients, and c) coefficients of gradation. The uniformity coefficient (C_{U}) is calculated as the ratio of the diameter corresponding to 60% finer in particle-size distribution (D₆₀) to the diameter corresponding 10% finer (D₁₀). The coefficient of gradation (C_{C}) is expressed as the ratio of the D₃₀² and the product of D₁₀ and D₆₀, where D₃₀ is the diameter corresponding to 30% finer in particle size distribution.

TABLE 3-2
Physical Characteristics of Cap Materials

| | | Moisture | Specific | Effective Size | | | | |
|---|---|---|---|---|---|---|---|---|
| | | Content | Gravity | D₁₀ | D₃₀ | D₆₀ | C_{U} | C_{C} |
| Cap Material | Visual Description | (%) | * | (mm) | (mm) | (mm) | * | * |
| Bay Mud | Dark gray clay | 30.6 | 2.78 | NA | NA | 0.0034 | NA | NA |
| AquaGate | Dark bluish gray | 1.5 | 3.39 | 1.84 | 5.24 | 7.41 | 4.02 | 2.01 |
| | well-graded gravel | | | | | | | |
| Apatite II ™ | Pale yellow poorly | 9.2 | 2.12 | 0.091 | 0.18 | 0.72 | 7.89 | 0.51 |
| | graded | | | | | | | |
| Macroporous | Strong brown | 4.0 | 3.64 | 0.48 | 0.73 | 1.16 | 2.39 | 0.94 |
| Aluminosilicate | poorly graded | | | | | | | |

* dimensionless.
NA: not applicable.
The hydrometer analysis showed percent sand, silt, and clay in Bay Mud are 0.7%, 49.4%, and 49.9%, respectively.

### 3.2 Total Metal Concentrations in Sediment and Porewater

### 3.2.1 Test Procedure

Pore waters were extracted from the sediment samples. Sediments (un-extracted) and porewater samples were analyzed for total metals (As, Cd, Cu, Fe, Pb, Hg, Se, and Zn) concentrations. The sample preparation and digestion procedures followed EPA SW 846 Method 3050B and metal analyses (except Hg) were conducted using EPA Method 6020 using Inductively Coupled Plasma-Mass Spectrometry (ICP-MS). Hg concentrations were analyzed following EPA Method 7471A using Cold Vapor Atomic Absorption (CVAA).

### 3.2.2 Results

### 3.3 Batch Sorption Capacity Tests

### 3.3.1 Sorption Isotherm Test Procedure

Batch sorption tests were conducted by equilibrating the selected cap materials (sorbent) and the site-specific water as per Barth et al. (2007). The sediment, Bay Mud, and water samples were stored in a refrigerator, at a temperature 4±2° C. until such time as the tests began. The other cap materials were stored in room temperature until tests began. The tests with As were conducted inside a glove compartment to maintain oxygen-free (argon) environment. The water samples were mixed with equal portions to obtain a site specific homogenized water sample. Proper care was taken to avoid transfer of suspended and settled particles present in the water container by carefully siphoning water from a polyethylene terephthalate (PET) carboy to a 47 liter polypropylene mixing container. Once homogenized, the mixed site water was used to prepare the stock solutions and used for the control tests. The stock solutions were prepared separately using Sodium Arsenite (NaAsO₂) (Ricca Chemical Catalog #RDCS0280100 with 99% purity) and Copper Nitrate Trihydrate (Cu[NO₃]₂. 3[H₂O]) (Fisher/Acros Chemical Catalog#AC20768-500 with 99% purity) each with four different concentrations: 50, 500, 1000, 5000 mg/L. A separate series of tests were conducted using site-specific water without any chemical spike. The sediment samples were homogenized in the shipped buckets using paddle stirring device and mixing at low speed until sediment has a uniform consistency. The sediment samples were sieved through a #10 sieve (Stainless Steel-8-inch OD ASTM E-11, Cole Parmer, FH-SS-SS-US-10) prior to use in order to screen out vegetative matter. The percent moisture content of the sediment samples were reanalyzed to report the homogenized wet samples as dry weight basis. The sorption test results in this disclosure are presented as dry weight basis. The batch sorption tests were conducted in triplicates using 150-mL pre-cleaned PET bottles with High-density polyethylene (HDPE) lined caps. About 100 mg of sorbent (sediment or cap material) was added into the test bottles using a precision balance (American Scientific Products, Model #ER-180A, accurate to ±0.0001 g). The control solutions and chemical-spiked solutions were poured into the bottles leaving no headspace and capped tightly. The weights of all solids and liquids added to each bottle were recorded gravimetrically. After mixing the test bottles on a Glas-Col vortex shaker (Model #099A DPM12) for 30 seconds, the bottles were placed into an Environmental Express (Model #LE1002) Toxicity characteristic leaching procedure (TCLP) Rotator for end-over-end tumbling. The tumbling was conducted at approximately 23° C., with a rotation of approximately 30 rotations per minute (RPM) for 48 hours. After equilibration, an aliquot of the sample was transferred to a 50-mL plastic container for pH analysis. The remaining portion of the sample was filtered using Teflon Filtermate 0.45 μm dissolved metal filter (Environmental Express Catalog #SC0407). The filtrate was acidified with nitric acid to a pH<2 and digested following EPA Method 3005A—Acid Digestion of Waters for Total Recoverable or Dissolved Metals. The metal (Cu and/or As) concentrations were analyzed by ICP-MS (EPA Method 6020). Initial and final equilibrium pH values were recorded.

### 3.3.2 Results

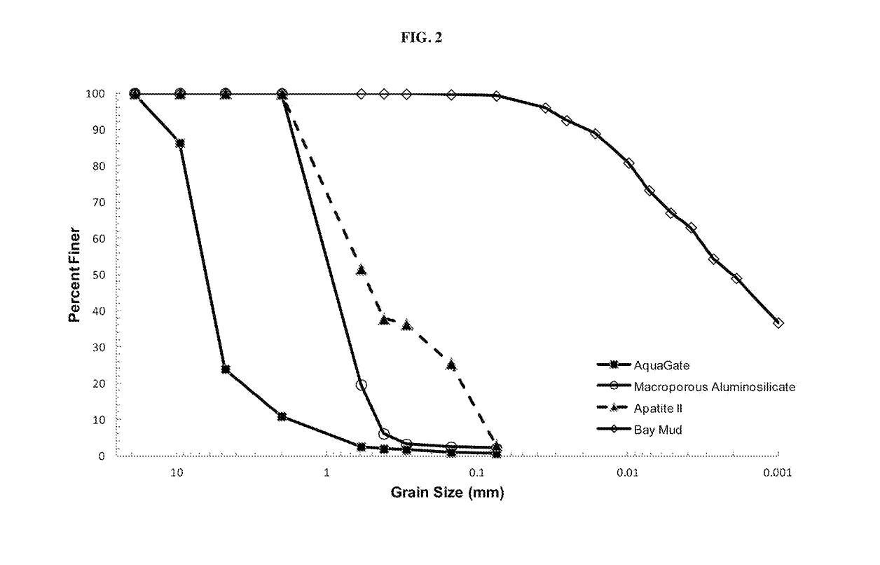

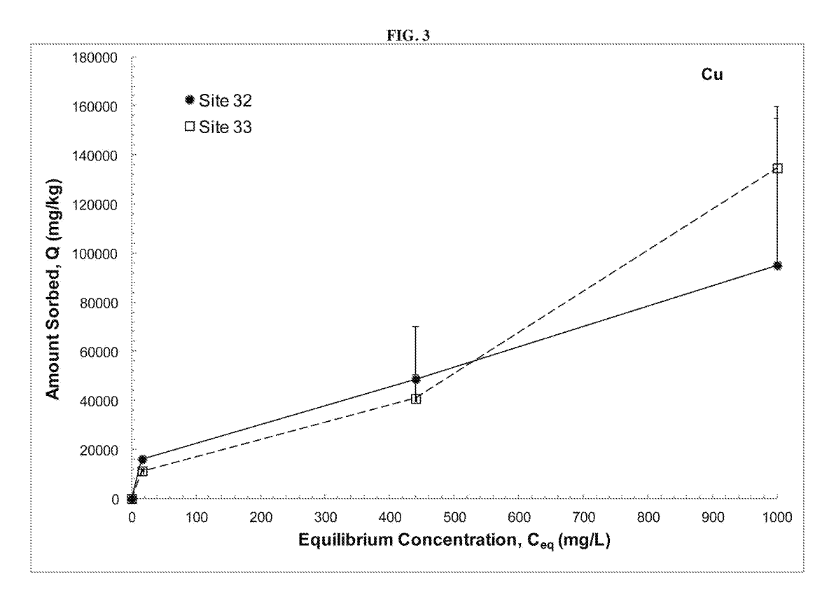

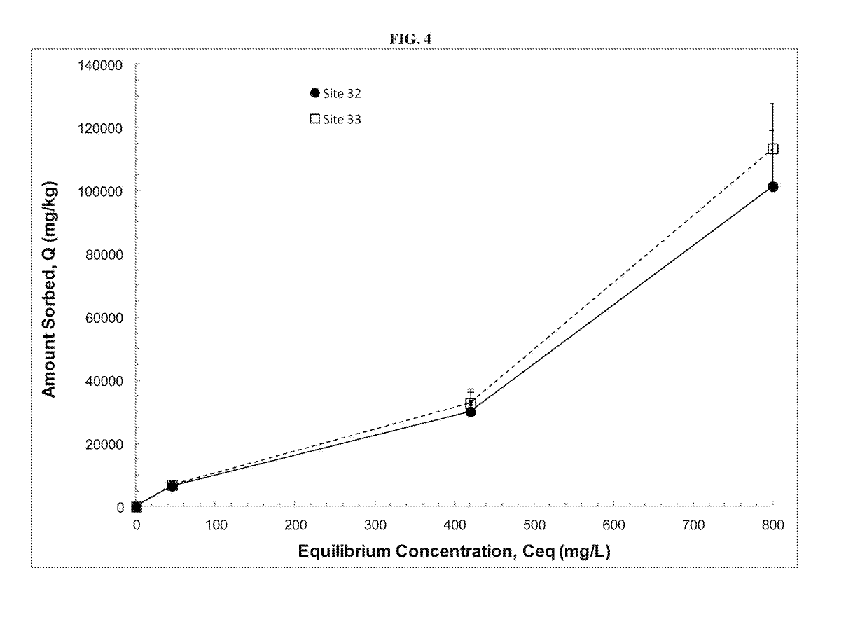

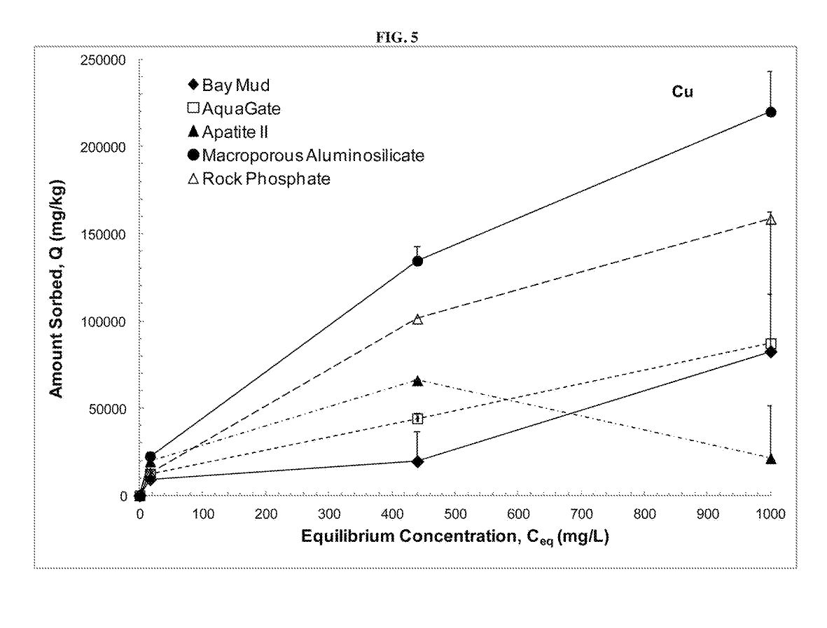

The sorption isotherms were prepared based on the initial and final concentrations of total dissolved metals (Cu or As) in the test bottles to determine the amount of metal sorbed onto the solid media. The amount of metals sorbed per unit weight of sorbent material has been plotted with respect to the increase in the equilibrium concentrations of Cu and As. FIGS. 3 and 4 show the sorption isotherms of Cu and As on the grab sediment samples collected from site. The sorption isotherms for the selected cap materials are shown in FIGS. 5 and 6. The amount of Cu and As sorbed per unit weight of native sediment increased with increase in concentrations of Cu and As till 1000 mg/L of initial concentrations of the both chemicals. The amount of Cu sorbed on Site 33 sediment samples decreased from 134,729 mg/kg to 68,155 mg/kg as the initial Cu concentration was increased from 1000 mg/L to 5000 mg/L. For the evaluation purpose of the sediment and cap materials, the sorption isotherms were evaluated for the four initial concentrations (i.e., 0, 50, 500, and 1000 mg/L) of Cu and As.

The amount of Cu and As sorbed per unit weight of cap material mostly increased with an increase in the concentration of corresponding contaminants (FIGS. 5 and 6). The saturation concentrations of Cu and As were not reached for any of the materials tested, which indicates that there are sorption sites remaining even at these high concentrations of metals. The partitioning coefficients (kd) of equilibrium concentrations of Cu and As in the site-specific water (spiked and unspiked) on sediments and cap materials are shown in Tables 3-3 and 3-4, respectively. In general, the amount of Cu sorbed can be ranked in the following order: Porous Alumniosilicate>>Phosphate Rock>Apatite II>Bay Mud≈AquaGate. The amount of As sorbed by the cap materials can be ranked in the following order: Porous Alumniosilicate>>Bay Mud≈Apatite II>AquaGate>Phosphate Rock.

The selected sorbents have adequate sorption capacity to attenuate Cu and As. Although the phosphate containing materials (Apatite II and Phosphate Rock) showed some sequestration of As in the site-specific water, Bostick et al. (2003) described that the removal of contaminant oxyanions (such as, selenite, SeO₃⁻², arsenate, AsO₄⁻³, and chromate, CrO₄⁻²) to Apatite II batch tests was less successful, but SeO₃⁻² showed nonlinear sorption isotherms, with projected sorption for low levels of soluble contaminant. Similar trend also observed for As in presence of Apatite II in the present study. Bostick et al. (2003) reported the affinity for cationic contaminants on Apatite II follows the approximate series (ranked by decreasing magnitude of the contaminant Kd, at lowest solution phase residual concentration evaluated) with respect to the present site-specific contaminants of interest as follows: Pb⁺²>Cd⁺²>Zn⁺²>Cu⁺²≈Hg⁺².

In a separate batch scale study, sorption tests were conducted using Cu-spiked distilled water with initial standard solution containing 10,000 mg/L of Cu, 1 mM sodium bicarbonate (NaHCO₃) and 10 mM sodium nitrate (NaNO₃). This series of tests was conducted using tap water instead of any site specific water. The test containers container containing sorbents and Cu-spiked aqueous solutions were equilibrated for these series of tests for 24 hours. The Kd values of these sorbents at two different sorbent loadings are summarized in Table 3-3a.

TABLE 3-3
Partitioning Coefficient (Kd) of Cu on Sediments and
Cap Materials Using Site-Specific Water

| | Grab Sediment | | | | | | |
|---|---|---|---|---|---|---|---|
| | Site | Site | Cap Materials | | | | |
| Equilibrium | Location | Location | | | | Phosphate | Macroporous |
| Concentration | # 1 | # 2 | Bay Mud | AquaGate | Apatite II | Rock | Aluminosilicate |
| (mg/L) | (L/kg) | (L/kg) | (L/kg) | (L/kg) | (L/kg) | (L/kg) | (L/kg) |
| 0.028 | 907.5 | 1424.5 | 1399.6 | 1484.1 | 1388.0 | 1236.9 | 1436.4 |
| 16.5 | 976.7 | 682.6 | 563.3 | 754.1 | 1179.4 | 795.6 | 1361.9 |
| 440 | 110.6 | 92.7 | 44.4 | 100.3 | 149.9 | 230.2 | 305.7 |
| 1000 | 95.1 | 134.7 | 82.6 | 87.2 | 21.3 | 158.4 | 219.9 |

TABLE 3-3a
Partitioning Coefficient (Kd) of Cu on
Cap Materials Using Distilled Water

| | Sorbent | |
|---|---|---|
| Sorbents | Loading (mg) | Kd (L/kg) |
| Activated Carbon | 1000 | 5,837 |
| | 50 | 6,846 |
| Chelating Organoclay | 1000 | 3,445 |
| | 100 | 3,104 |
| Kaolinite | 1000 | 354 |
| | 100 | 2,318 |
| PM 199 | 1000 | 708 |
| | 50 | 191 |
| Nanosorbent | 100 | 10,290 |
| | 10 | 501 |
| Partitioning Organoclay | 1000 | 2,596 |
| | 100 | 296 |
| Rice Husk | 1000 | 176.7 |
| | 100 | 2.34 |
| Macroporous Aluminosilicate | 1000 | 400,154 |
| | 100 | 513,064 |
| Sand | 1000 | 1.6 |
| | 100 | 2.34 |

TABLE 3-4
Partitioning Coefficient (Kd) of As on Sediments and Cap Materials

| | Grab Sediment | | | | | | |
|---|---|---|---|---|---|---|---|
| | Site | Site | Cap Materials | | | | |
| Equilibrium | Location | Location | | | | Phosphate | Porous |
| Concentration | # 1 | # 2 | Bay Mud | AquaGate | Apatite II | Rock | Aluminosilicate |
| (mg/L) | (L/kg) | (L/kg) | (L/kg) | (L/kg) | (L/kg) | (L/kg) | (L/kg) |
| 0.034 | 58.5 | 1448.5 | 1339.1 | 1457.1 | 989.7 | 76.3 | 1503.8 |
| 45 | 146.1 | 153.5 | 123.8 | 134.4 | 104.6 | 101.9 | 236.5 |
| 420 | 71.7 | 78.1 | 81.2 | 81.1 | 49.3 | 922.1 | 85.3 |
| 800 | 126.7 | 141.8 | 149.1 | 138.8 | 149.1 | 133.9 | 196.1 |

### 3.4 Leaching Tests of Cap Materials

### 3.4.1 Batch Leaching Test Procedure

Waste Extraction Test (WET), a leaching test developed by Department of Toxic Substances Control (DTSC) (see California Code of Regulations, Title 22, Chapter 11, Appendix 2), is one of the test methods used in California to determine whether a waste is a toxic hazardous waste. This test uses a combination of 0.2 M citric acid solution and 4.0 N NaOH to make leaching solution of pH 5.0±0.1. The deionized (DI) water-WET, developed by the Water Board, was used to characterize the amount of metals that would leach from a solid matrix by DI water. This test used the same test as the WET, but used DI water as the leaching agent. Generally, one liter of DI water was added to a 100-gram sample and equilibrated for 48 hours. After rotation, the sample was filtered and analyzed for metals.

### 3.4.2 Results

A chemical must be available to an organism before it can be accumulated or cause an adverse effect. The fraction of the total environmental concentration that is available for uptake and accumulation by ecological receptors is considered the bioavailable fraction. For sediments and water systems, indirect methods of assessing bioavailability include correlating bulk chemistry with chemical extraction of sediment (such as, the DI-WET), and analyzing other parameters that may affect bioavailability, including pH, ORP, total organic carbon, salinity, hardness, and grain size. Metals generally exist in dissolved complexes (free metals or inorganic and organic complexes), non-dissolved complexes (inorganic or organic such as complexes involving humic substances), or particulate phases (sorbed to sediment particles, organic detritus, or living periphyton or plankton). Not all soluble metal complexes are available; in general, free metal ions are more available. In environmental settings similar to the sites from where these samples were collected, sulfur, iron, and manganese are the important elements involved in redox processes in submerged sediments. Measurements of concentrations of total metals and leachable in the cap materials have been conducted to make sure that these materials are not contributing significant amount of bioavailable chemicals. Total metal concentrations in the cap materials do not necessarily reflect the amount of a contaminant available to the receptors. Total concentrations include structural ions that may not partition with soluble phases associated with uptake by plants or dermal and trophic uptake by animals. Aqueous extractions of metals, such as the DI-WET, can represent the soluble component of weakly-bound contaminants.

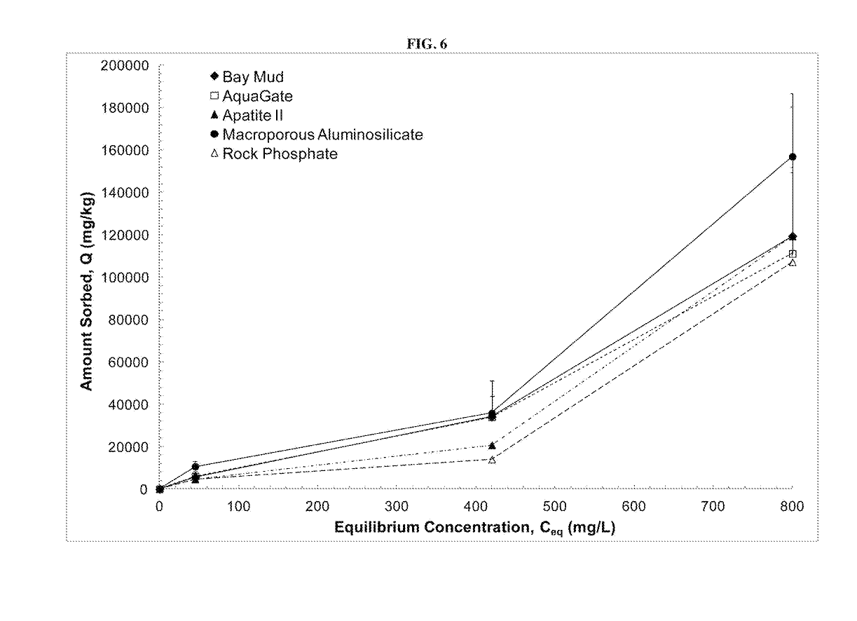

The total concentrations of TAL metals (Al, Sb, As, Ba, Be, Cd, Cr, Co, Cu, Fe, Pb, Mn, Hg, Mo, Ni, Se, Ag, Tl, Va, and Zn) present in the cap materials were analyzed and plotted in FIG. 7. The concentrations of Al and Fe were relatively high as they are the major ingredients of the selected cap materials. The cap materials showed the presence of other metals as these metals are naturally present in the mineralogical structures. The concentrations of metals present in the leachate of the DI-WET are also plotted as line connected scattered points in FIG. 7. DI-WET results showed presence of key ingredients, like Al, Fe, and Mn, that are basic structural minerals of the cap materials. Apatite 11 showed a peak of As concentration in the DI-WET leachate. Though significant amount of Fe was present in the Apatite II structure, it appears that these Fe were not able to bind the available As.

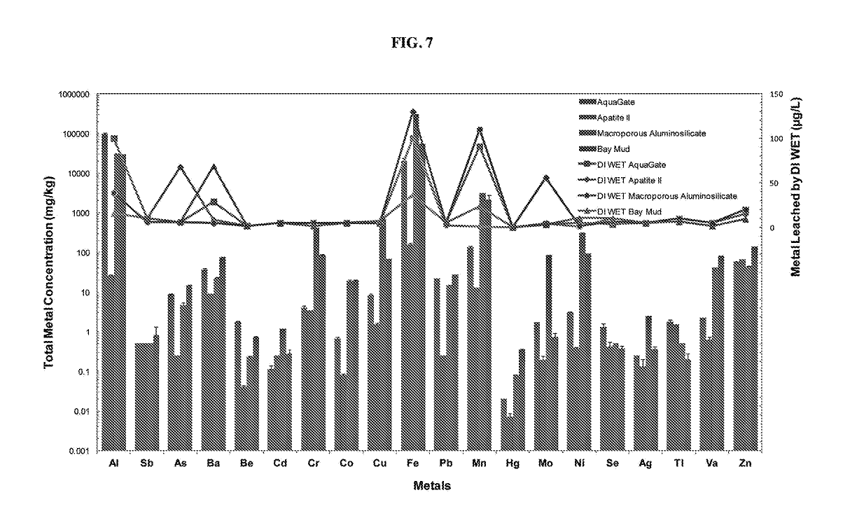

The concentrations of selected metals in the DI-WET leachate and the water quality screening criteria were compared in FIG. 8. The concentrations of metals as the water quality screening limits were considered based on marine chronic ambient water quality criteria California Region Water Board Basin Plan, National Ambient Water Quality Criteria (AWQC) or California Toxics Rule. Most of the tested metal concentrations in DI-WET are in general lower than the freshwater acute and chronic AWQC and marine chronic AWQC. The concentration of leachable As (68 μg/L) from the Apatite II during the DI-WET test was lower than the freshwater acute (340 μg/L) and chronic (150 μg/L) AWQC, however, higher than the marine chronic (36 μg/L) and acute (69 μg/L) AWQC. It should be noted that the total As concentrations in the Apatite II was relatively smaller (0.25 mg/kg) with respect to the average concentrations of As present in other selected cap materials (8.75, 4.65, and 14.67 mg/kg for AquaGate, Porous Aluminosilicate, and Bay Mud, respectively). The desorption tests, described in next section (Section 3.5), provide additional information on potential mobility of As, if any, by the cap materials.

### 3.5 Desorption of Contaminants from Cap Materials

### 3.5.1 Desorption Test Procedure

The desorption tests were conducted for Bay Mud, AquaGate, Porous Aluminosilicate, Apatite II, and Phosphate Rock in presence of site-specific sediments and DI water (ultrapure 18 Megaohm quality water from US Filter/Siemens system). The sediment samples that were collected in 5-gallon plastic containers from locations historically containing high concentrations of metals to insure presence of bound metals. The sediments were homogenized by a paddle stirring device at low speed until the sediment had a uniform consistency. The sediment and Bay Mud samples were sieved through a #10 sieve (Stainless Steel-8˜inch OD ASTM E-11, Cole Parmer, FH-SS-SS-US-10) prior to use in order to remove vegetative matter. The percent moisture content of the sediment samples were reanalyzed to report the homogenized wet samples as dry weight basis. The potential mobilization of metals, if any, by the cap materials was determined by adding 5% by weight of each cap material (except Phosphate Rock, which was added at 8% by weight) to 12 g (dry weight basis) homogenized sediment. Appropriate corrections in weight of solids added were conducted to consider the moisture content of the solid phases. These desorption tests were conducted using 150-mL PET bottles with polyethylene lined screwed cap (QEC catalog #6213-0005PET) container using 60-mL of DI water. The same amount of DI water were added in the desorption test bottles. After addition of DI water, the slurry in each bottle should be homogenized by shaking for one minute on the Glas-Col vortex shaker (Model 099A DPM12). These desorption tests were conducted in triplicates (except Apatite II, which will be conducted in duplicates and Phosphate Rock, which was conducted as a single series of tests). In addition, control tests (without cap material) were conducted using site-specific sediments and DI water. After mixing on the vortex shaker, the test bottles were placed the bottles with sediment/sorbent mixtures into the TCLP Rotator for end-over-end tumbling at 23±2° C. rotating at 30±2 RPM for 48±2 hours. After equilibrating for 48 hours, portions of the samples were analyzed for pH and the remaining portions of the samples were allowed to settle, and then the supernatant liquids were filtered using Whatman® 0.45-μm dissolved metals filters (Catalog#09-905-17) and Kontes Scientific glass filtration apparatus (Catalog#953870-1000). The filtrates were collected into 50-mL polyethylene bottles, acidified with nitric acid to a pH<2. These samples were split into two portions, with one portion being prepared following EPA Method 3005A (Acid Digestion of Waters for Total Recoverable or Dissolved Metals) and the other portion prepared following EPA Method 7470A (Mercury in Liquid Waste). Seven metals (As, Cd, Cu, Fe, Pb, Sc, and Zn) were analyzed using EPA Method 6020 by ICP-MS (Agilent ICP-MS Model 7500ce) and Hg was analyzed using EPA Method 7470A by CVAA (CETAC Model M6100).

### 3.5.2 Results

Heavy metals are naturally-occurring in the environment and tend to adsorb strongly to clays, muds, humic, and organic materials. However, they can be mobile in the environment depending upon the pH, hardness, salinity, oxidation state of the element, soil saturation, and other factors. Competitive ion displacement can represent an important means by which metals, especially As, are released to the aqueous phase and can be subject to transport. Ion-exchange takes place between phosphate (PO₄) and As as they share many similar properties and often compete for the same surface sorption sites. Displacement and mobilization of As by phosphates is of particular concern, and reported in regions where fertilizer or pesticide runoff and leaching occurs are specifically at risk for this mobilization pathway (Jain and Loeppert, 2000; Peryea and Kammerack, 1997). Dissolved silicate and organic matter can also competitively limit As sorption or promote desorption, with concentrations common to sediments having an appreciable impact on dissolved As concentrations. Carbonate can also compete with arsenic for sorption sites on mineral surfaces, and natural organic matter may also compete with As and inhibit arsenic sorption onto iron (hydr)oxides due to competitive sorption (Xu et al., 1991; Redman et al., 2002). Speciation (or oxidation state) of As plays an important role in its bioavailability in the sediment-water systems. Arsenate (As V) desorption from iron (hydr)oxides is measurable but limited, while arsenite (As III), in comparison, undergoes extensive release under hydrodynamic conditions. The extensive yet apparently weaker adsorption of As III can be rectified by considering the multitude of potential surface complexes on sediment cap surface layers. As III binds on iron (hydr)oxides through multiple inner-sphere complexes, having a range of binding strengths, in combination with outer-sphere and H-bonded moieties, giving rise to extensive but weak complexes. As III forms more labile complexes on ferric (hydr)oxides and challenges the presumption that iron reduction is the primary factor liberating arsenic to the aqueous phase. Arsenic reduction, in fact, may have a more pronounced role in destabilizing arsenic and allowing its transport within soils.

### 3.6 Settling Velocity

### 3.6.1 Test Procedure

The settling velocity of sediment is one of the key variables in the study of sediment transport, especially when suspension is the dominant process, since it serves to characterize the restoring forces opposing turbulent entraining forces acting on the particle. In spite of this importance, it is nearly impossible to obtain its actual value in situ, and in most cases it is obtained from laboratory experiments or predicted by empirical formulas. Settling velocity tests were performed for the potential cap materials by using the method described as follows.

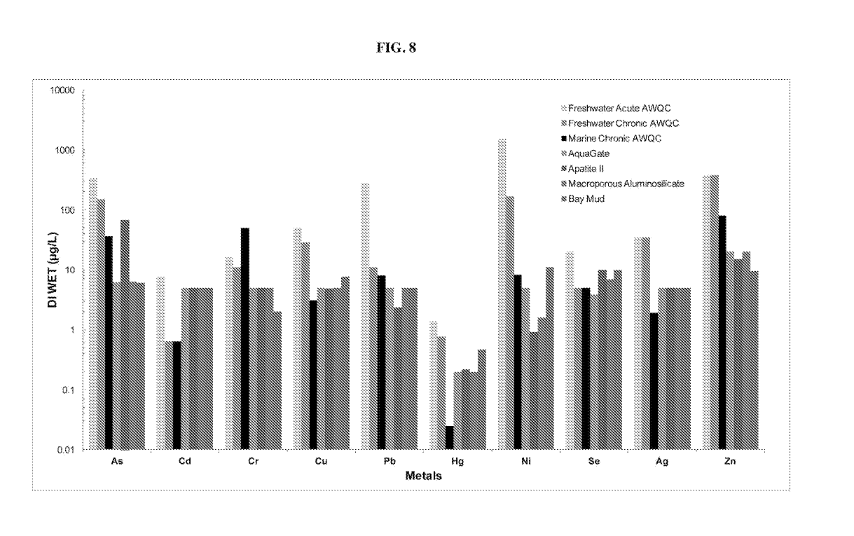

This method used 2-L graduated cylinder containing site water and selected cap material (Chattopadhyay et al., 2005). Cap materials, as received, were tested by settling of solid materials under their own weight through still fluid (site-specific water). When placed in the fluid, a solid body denser than the fluid settles downward and a solid body less dense than the fluid rises upward. When a non-neutrally buoyant body is released from rest in a still fluid, it accelerates in response to the force of gravity. As the velocity of the body increases, the oppositely directed drag force exerted by the fluid grows until it eventually equals the submerged weight of the body, whereupon the body no longer accelerates but falls (or rises) at its terminal velocity, also called the fall velocity or settling velocity in the case of settling bodies (FIG. 9). The terminal or free settling velocity was calculated under the action of gravity as given by:

$${u}_{t} = \sqrt{\frac{2 g \cdot {m}_{p} ( {ρ}_{p } - ρ )}{{ρρ}_{p} {A}_{p} C}}$$

where,

Uₜ=terminal or free velocity, g is acceleration due to gravity,

mₚ=mass of particle,

ρₚ=density of the particle,

ρ=density of the surrounding fluid,

Aₚ=the projected area of the particle in direction of motion.

The drag coefficient, C, was calculated assuming that the particles are spherical rigid particles. Drag coefficients were calculated for appropriate particle Reynolds numbers (NRe<0.1, 0.1>NRe>1000, and 1,000>NRe>350,000). The specific gravities and particle size distribution of various cap materials are discussed in Section 3.1.2.

### 3.6.2 Results

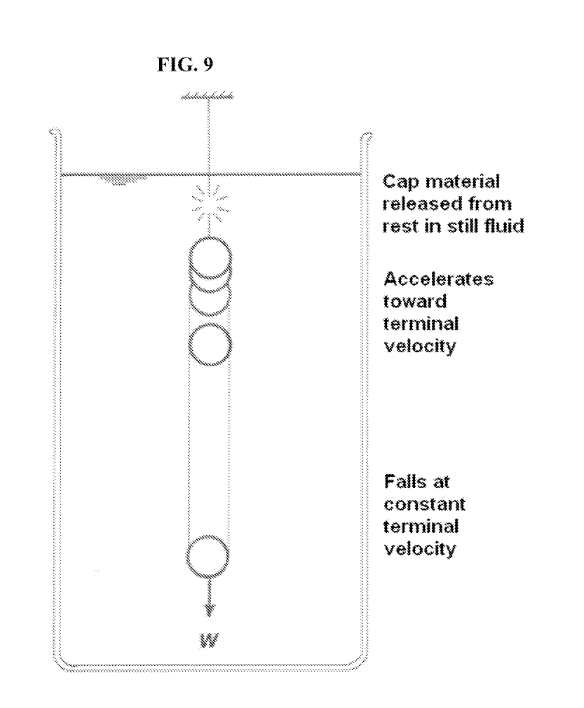

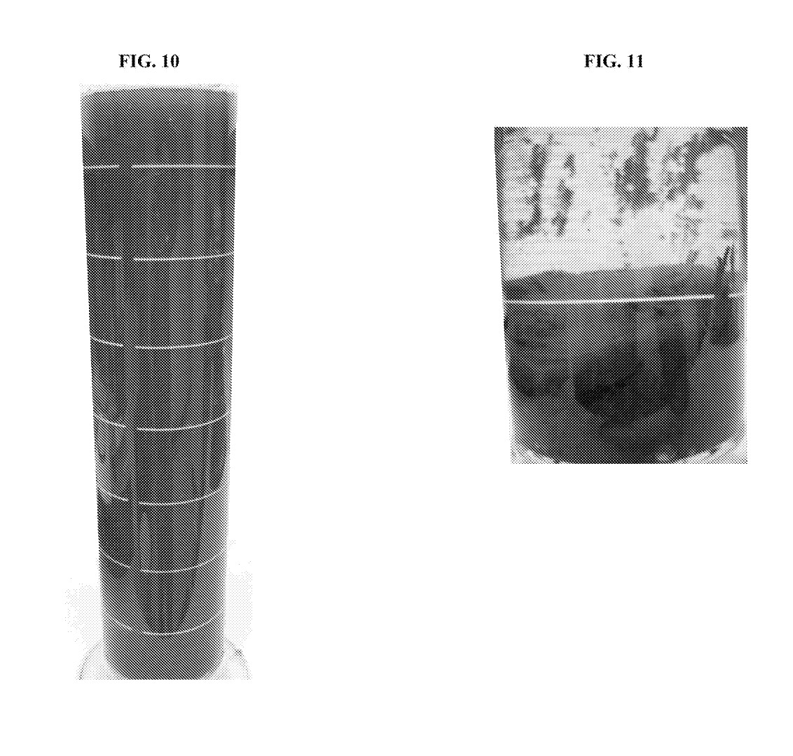

The sediment samples from the site formed a stable suspension indicating presence of fine particles associated with lighter organic-rich “fluffy” material. The suspension was settled after a period of 10 days. FIG. 10 shows the suspended sediment at the beginning of the test and FIG. 11 shows settled consolidated solid after 10 days. The settling velocities of the sediment samples were not calculated.

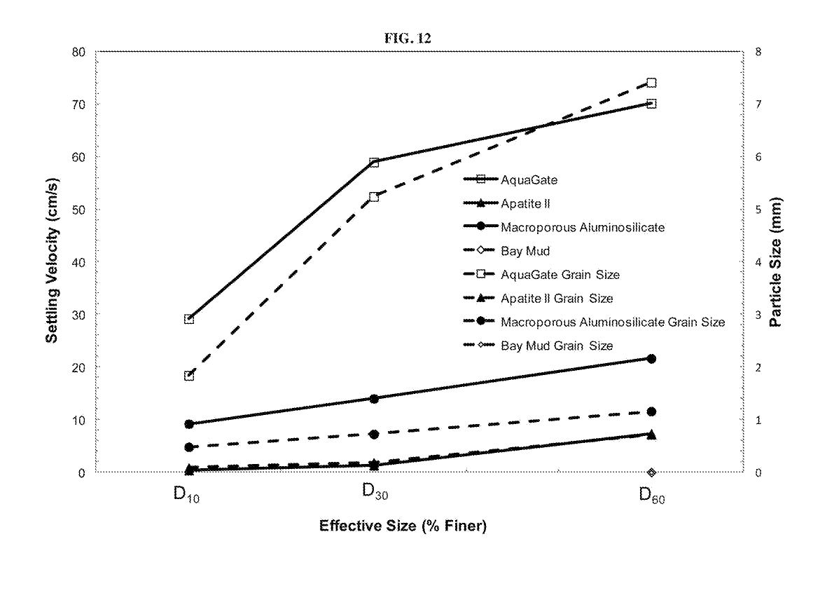

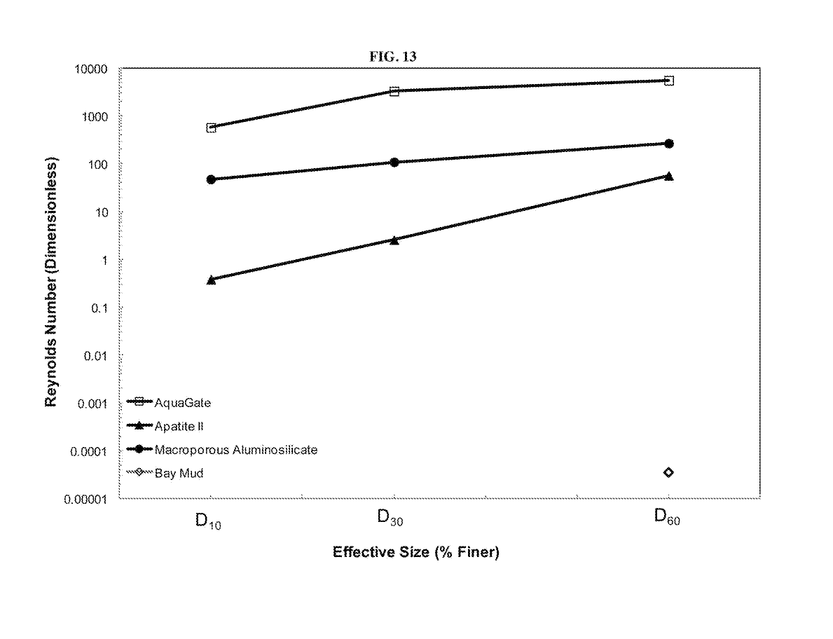

A settling velocity too low can result in a significant increase in water turbidity and reduction in water quality. Too high a velocity could cause compaction of the sediments, and release and mixing of potentially highly contaminated interstitial water into the surface water. Therefore, it is important to determine the settling velocity of each potential cap material. The settling velocities and flow condition (Reynolds number) of selected cap materials are plotted in FIGS. 12 and 13. All of the selected cap materials were settled within 30 minutes.

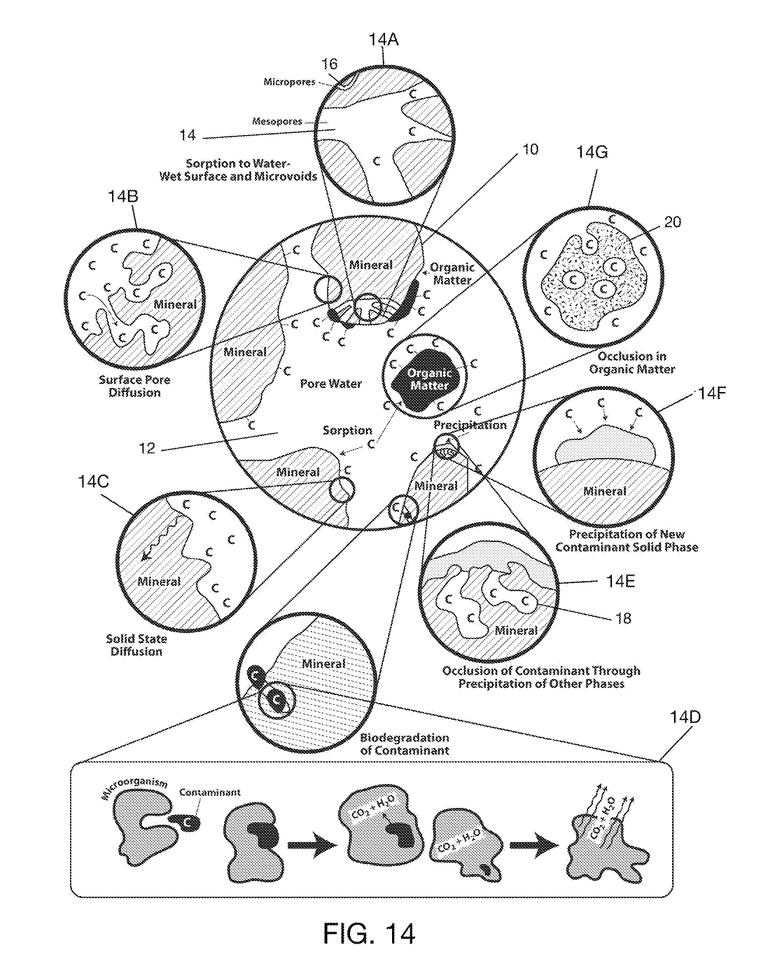

Based on the test results given above, the Macroporous Aluminosilicate bonded ceramic which includes interconnected macro-pores, meso-pores, and micropores is particularly well suited for remediation of aqueous environments as a capping material. FIG. 14 shows a close-up schematic view of a portion of a particle 10 of the novel material described herein including a macro-pore 12, meso-pores 14, and micro-pores 16 (shown in close-up view 14A). The letter “C” is shown to represent contaminants (or pollutants) that are drawn into the interior of the particle 10. Close-up view 14A shows sorption activity while close-up view 14B shows surface pore diffusion occurring. Close-up view 14C shows an example of solid state diffusion activity of contaminants while close-up views 14D(i) and 14D(ii) show an example of biodegradation of contaminants. Close-up views 14E and 14F show how contaminants can become occluded based on precipitation of new contaminant chemical phases 18. Finally, close-up view 14G shows an example of contaminants becoming occluded by organic matter 20 that was impregnated or otherwise grown in the macro-pore 12 of the particle 10 shown in FIG. 14.

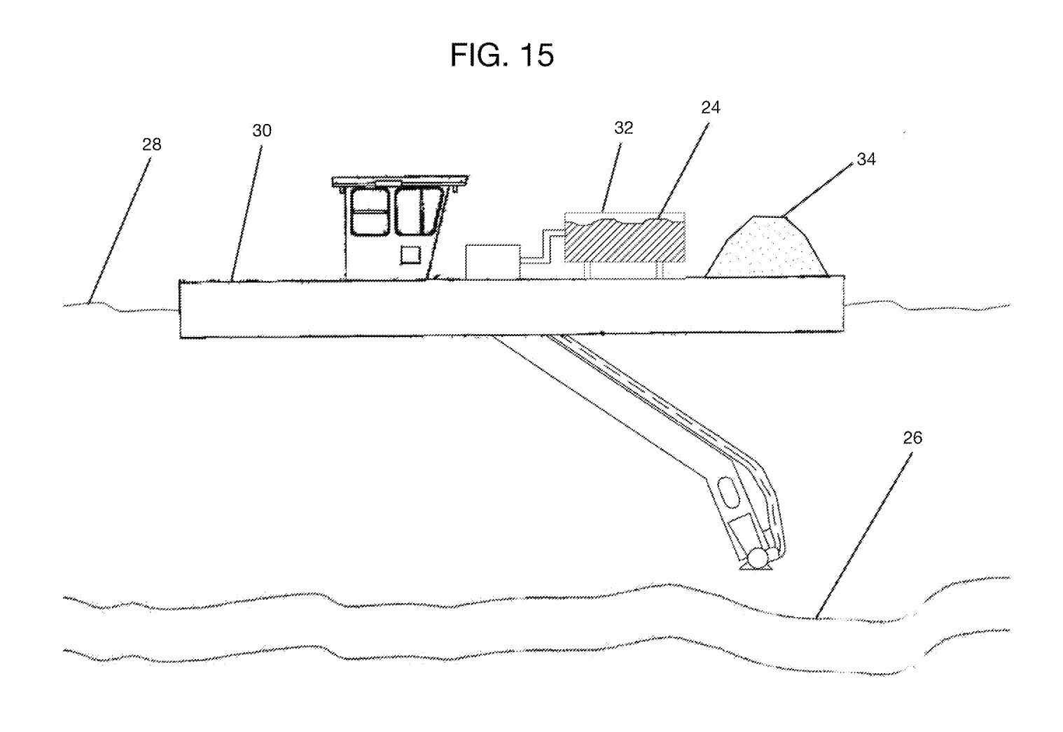

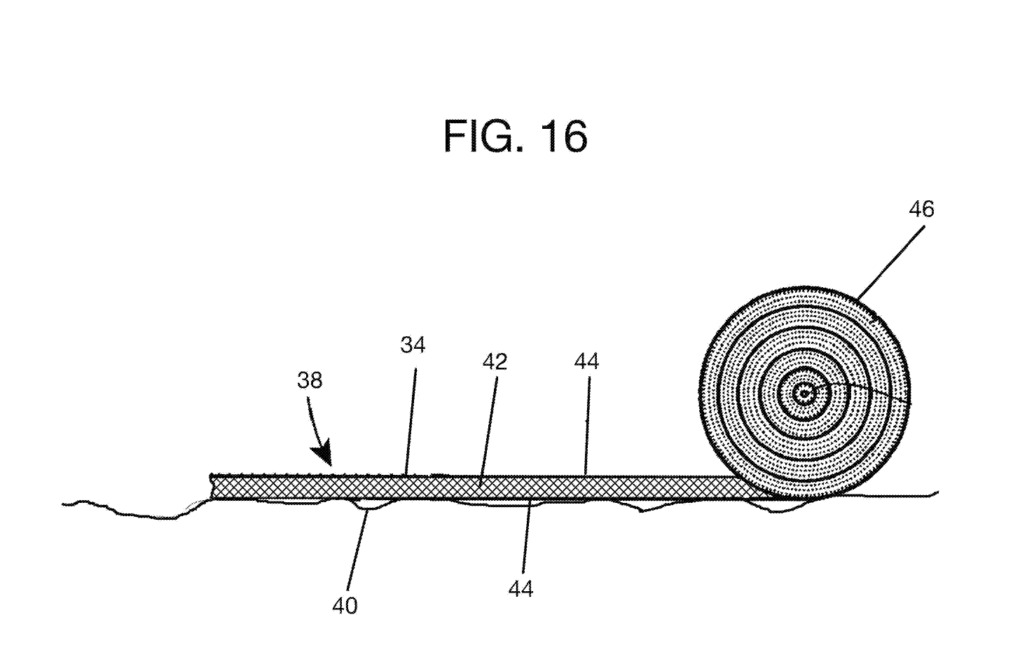

The novel material including particles with characteristics of the one shown in FIG. 15 can be used as a capping material 22 as shown in FIG. 16. Based on the Krumbein phi scale wherein D=Dₒ×2^{-φ}, D represents the diameter of the particle in meters and Dₒ represents a unitary constant, the size of the particles fall with a range of from about 32×10⁻³ meters to about 3.9×10⁻⁶ meters (−5≦φ<8). More preferably, the sizes of the particles preferably range from about 32×10⁻³ meters to about 2×10⁻³ (−5≦φ≦−1). The capping material 22 can be applied as dry solid or aqueous slurry 24 to an area proximate a sediment layer 26 of an aqueous environment 28. In one embodiment, the slurry 24 is pumped from a barge 30 which includes a mixing chamber 32 where surrounding water is mixed with solid material 34 including or consisting essentially of particles like particle 10 shown in FIG. 15. The slurry 24 is preferably kept at a desired bulk density within the mixing chamber and pumped to an area proximate the sediment layer 26 using a fluid pumping apparatus 36.

Another method of using the solid material 34 as a capping layer is to fill one or more mats 38 with the solid material 34 and then position the mats 38 along a sediment layer 40 shown in FIG. 16. The mats 38 can be presoaked with water prior to immersion in an aqueous environment or the mats 38 can be applied substantially dry and watered as the mats 38 are placed in their desired positions in the aqueous environment. The mats 38 can be made of natural, biodegradable polymer as described, for example, in the Background section of U.S. Pat. No. 6,207,114 entitled “Reactive Material Placement Technique for Groundwater Treatment” to Quinn et al., which is incorporated herein by reference. Preferably, the solid material 34 is maintained in a web matrix 42 within the one or more mats 38 by an outer polymer layer 44. After the mats 38 are exposed to the applicable aqueous environment for a minimum period of time (preferably measured in a few days) the permeability of the mats 38 increase as the outer polymer layer 44 begins to break down, allowing for water and any chemical species therein to interface with the solid material 34 inside the mats 38. As shown in FIG. 16, the mats 38 may be secured in one long continuous piece such that the mat may be placed into a roll 46 for shipping and storage of the mats 38. When installing the mats 38, the roll 46 may then be unrolled over the desired position in the aqueous environment.

The previously described embodiments of the present disclosure have many advantages, including a unique remediation material having (a) optimum bulk density so that this material can sink quickly in the majority of site-specific water columns and mostly remain on the top of native sediment (the remaining portion present as mixed layer with sediment), (b) high sorption capacity to sequester various types of contaminants, (c) high permeability due to its porous structure, (d) structure that allows for a high flowrate of upwelling water and biogenic gas, (e) the capability to remove more contaminant per unit weight than conventional treatment materials, (f) rapid operational capability requiring less contact time (minutes vs. hours), long lifespan for most applications compared to conventional treatment materials.

### 4. Qualitative Phase Analysis by X-Ray Powder Diffractometry

The interaction of x-rays with crystalline matter gives us coded information about crystal structure in the form of diffracted intensity (I) as a function of the measured diffraction angle 2θ. Knowing the radiation wavelength (λ) and measuring the diffraction angle (2θ) we can solve the Bragg Equation (nλ=2d sin θ) to obtain the interplanar distance (d) between related planes of atoms comprising the crystal lattice.

The objective is to identify the dominant crystalline phase(s) present in twelve samples (5 untreated and 7 treatments) using powder x-ray diffractometry. Phase selections are to be based on visual goodness-of-fit of the reference phase diffraction data compared to the experimental unknown diffraction patterns. Selections are also guided by FOMs from search/match of the reference phase database.

### 4.1 Method

### 4.1.1 Sample Preparation

Untreated samples were air-dried, crushed using an agate mortar and pestle (AquaGate and Bay Mud) or disc-milled (phosphate rock, macroporous aluminosilicate, and Apatite II) using a Stiebteknik (Angstrom Inc.) processional mill. Arsenic and copper treated sample suspensions (selected samples that were treated at highest initial spiked concentrations of As and Cu) were transferred to Teflon Oak Ridge-type 50-mL centrifuge tubes, balanced and centrifuged at 5000 rpm for 10 minutes using a Beckman Model J2-21 centrifuge equipped with an angle-head rotor. Decantates were retained, the solids were quick-frozen in liquid nitrogen, lyophilized for 36 hrs using a Labconco Model Freeze Dryer 8, and powdered using an agate mortar and pestle. Two-gram subsamples of the sediments (AGC-4 and MB-4) were placed inside 2-mL cuvettes and equilibrated with ethylene glycol vapor for 3 days inside a glass dessicator at 60° C. prior to scanning.

### 4.1.2 X-Ray Diffraction Analysis

The x-ray diffraction analysis was carried out using a Bruker D8 Advance Series II x-ray diffraction system equipped with K780 Generator operating at 40 kV and 40 mA, KFL 2.2 kW Cu tube, scintillation counter, diffracted-beam graphite crystal monochromator, 0.6-mm divergence slit, 0.6-mm anti-scatter slit, 0.1-mm receiving slit and 1.0-mm secondary monochromator anti-scatter slit. Powder specimens were top-loaded into 25.4-mm diameter Bruker powder mounts, the excess powder struck away from the mount surface so as to minimize preferred orientation and bring the specimen surface tangent to the goniometer circle. Instrumental settings are given in Table 1, sample scan settings are given in Table 2. The raw scans are collected using the Bruker XRD Commander data collection software.

### 4.2 Results

### 4.2.1 Crystallinity

Peak/background area ratios (Tables 4.3-4.7) described the coherent-diffracted fraction of the total intensity received at the detector resulting from constructive interactions between incident Cu-radiation and solid matter of medium- to long-range atomic periodicity (crystallinity). Based on peak/background area ratios, inferred relative crystallinities of untreated samples were in order of highest to lowest crystallinity PR-4>AGC-4>MB-4>MAC-4>AP2-4.

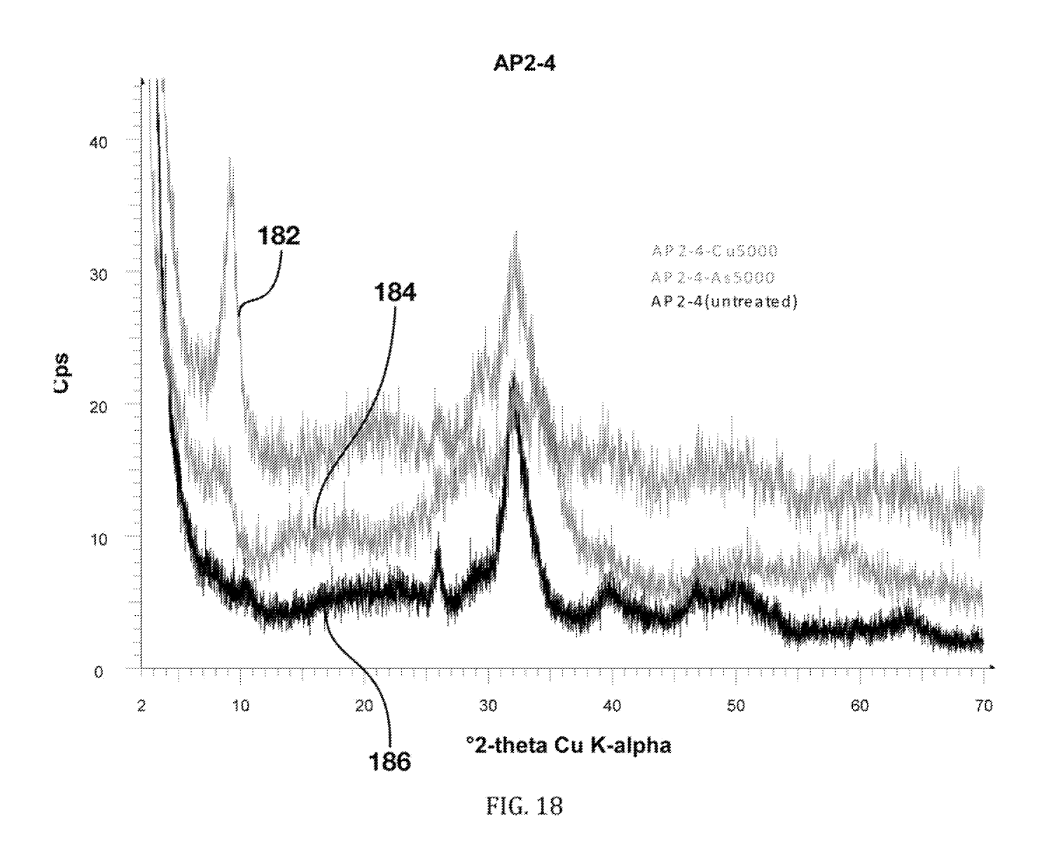

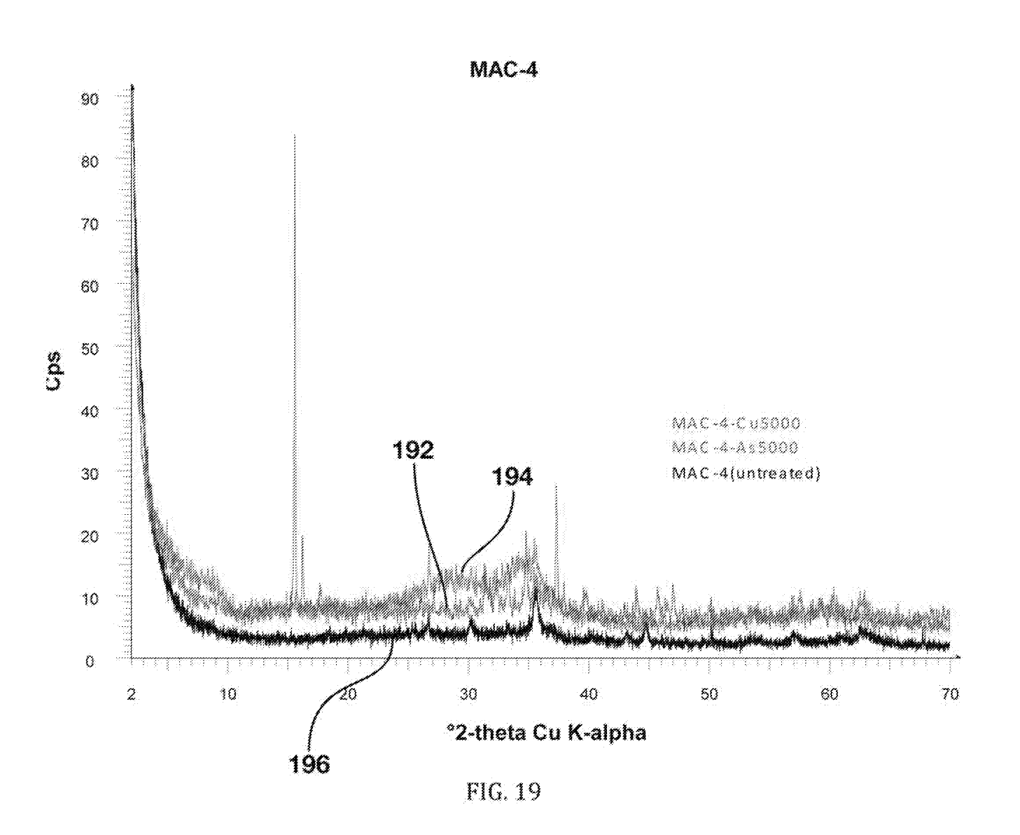

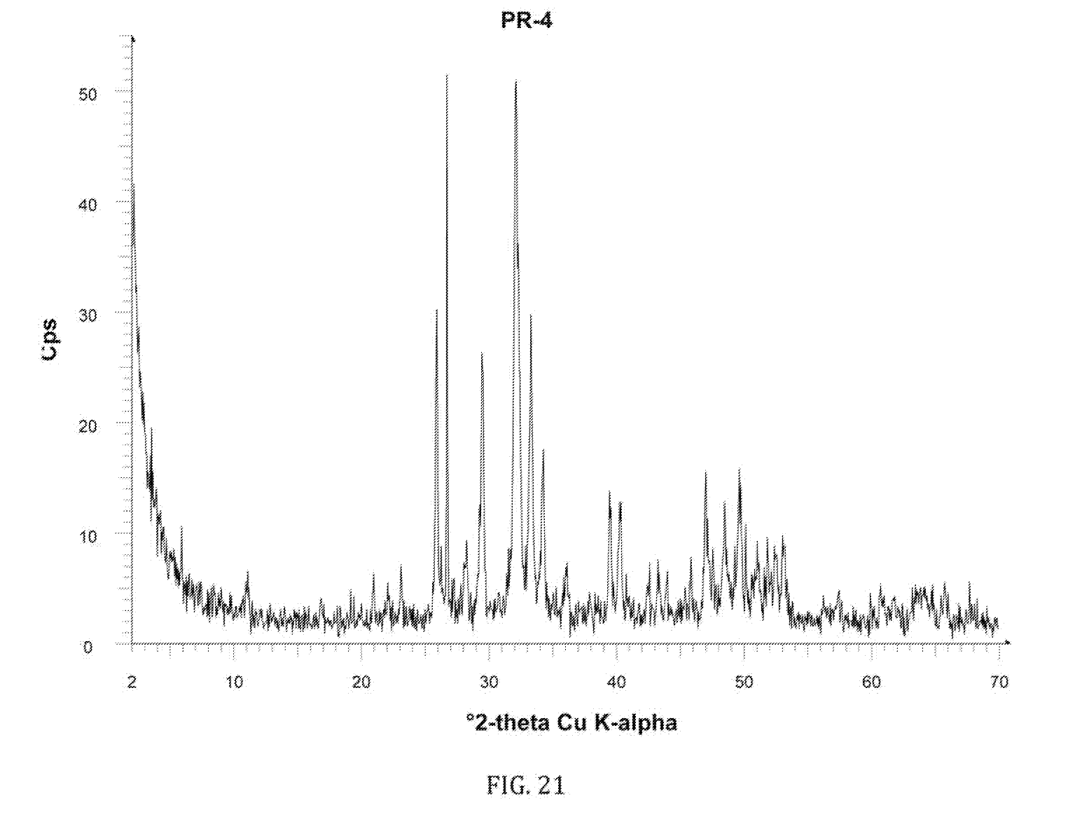

The raw scan of the rock phosphate sample (PR-4, FIG. 21) was described as a collection of sharp, high-intensity peaks of narrow width, suggesting considerable crystal development. By contrast, raw scans of the fishbone (AP2-4, FIG. 18) and ceramic (MAC-4, FIG. 19) samples possessed relatively wide, low-intensity peaks. Apparent termination of growth along crystallographic directions had given rise to small (nano) particles with limited development in the numbers of crystal planes needed to extinguish non-Bragg diffraction effects. These non-Bragg effects were expressed as intensity tailing off on low- and high-angle sides of peak maxima in the scans of AP2-4 and MAC-4. The porous materials have imperfections or interruptions in the physical continuity, lattice imperfections, broken bonds at the edges of the particles, and exposed structural hydroxyl ions. These properties lead to high surface area and associated higher sorption capacity of these materials.

### 4.2.2 Arsenic Treatments

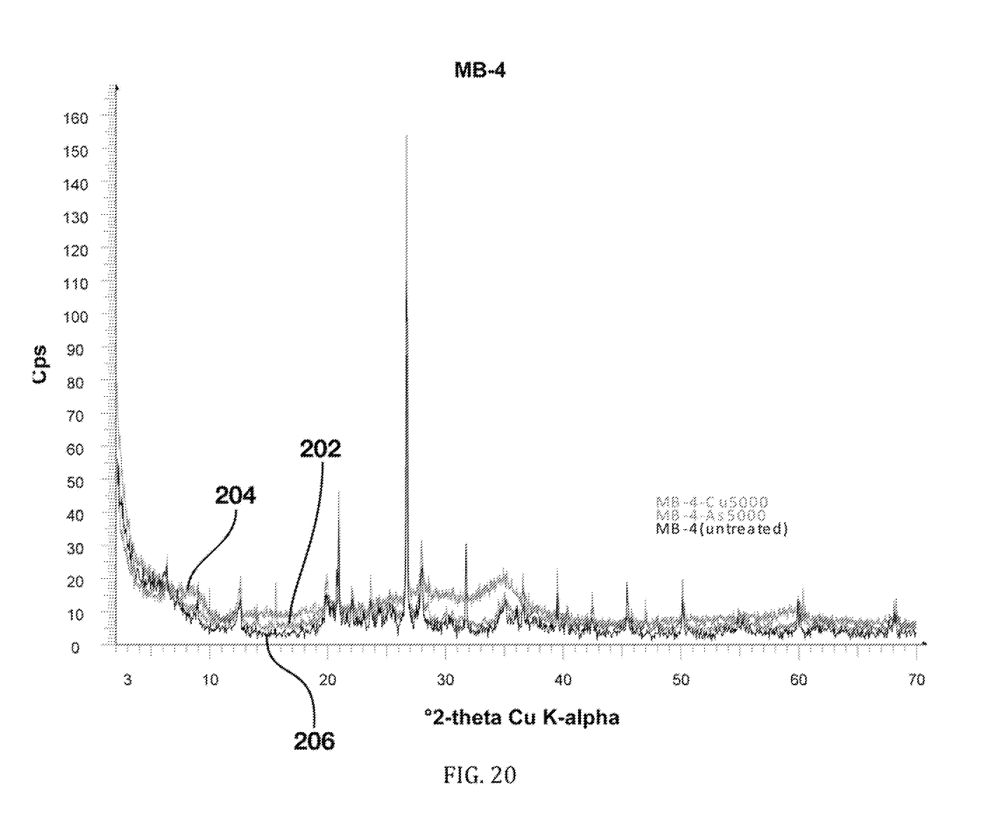

X-ray diffraction evidence for the presence of As-containing phase(s) was confined to small regions of non-null intensity near the background functions of AP2-4-As5000 184 (FIG. 18), MAC-4-As5000 194 (FIG. 19), and MB-4-As5000 204 (FIG. 20). Areas of diffracted intensity associated with As-treatments tended to be of wide angular breadth and lacking clear peak maxima, suggesting that products of interaction between As and substrates were of low-crystallinity. Intensities of residual peaks from the substrates were observed above high-background intensities in all As-treated spectra.

### 4.2.3 Copper Treatments

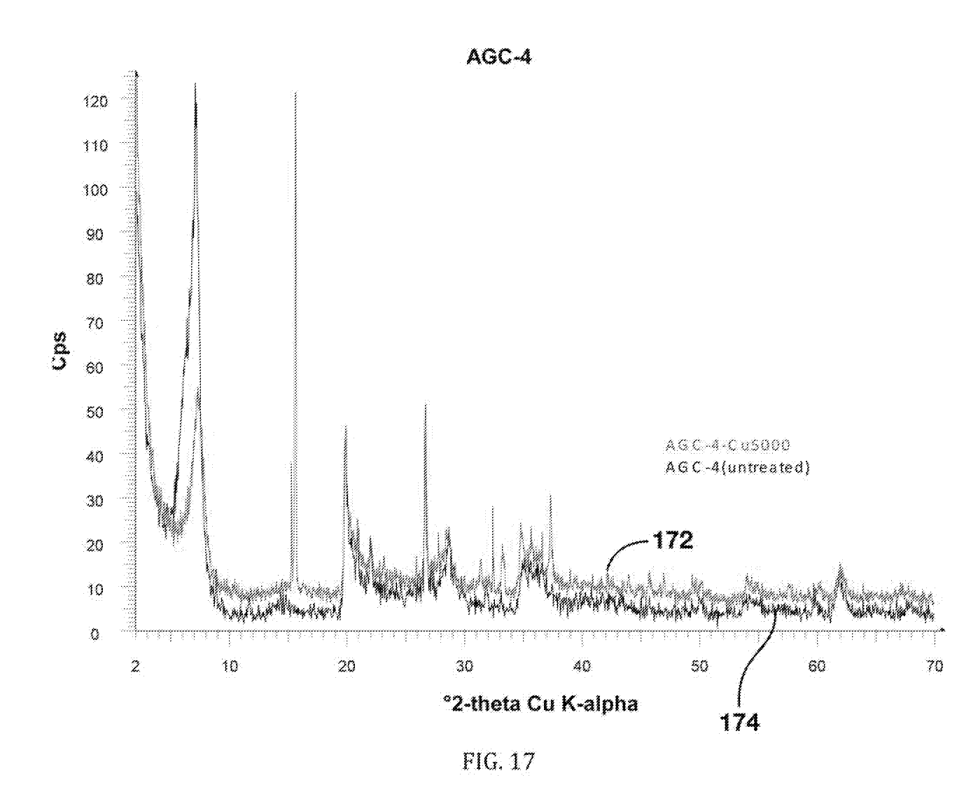

Absorption of Cu-radiation from the incident beam and emission of fluorescent Cu-radiation by Cu-containing samples contributed to relatively higher background intensities in the XRD spectra of Cu-treatments (FIGS. 17-20). Relative to the untreated analogs of AGC-4 174 (FIG. 17), AP 2-4 186 (FIG. 18), MAC-4 196 (FIG. 19), MB-4 (FIG. 20), the increased fluorescent intensities originated from smaller irradiated sample volumes.

Precipitation of a Cu-containing phase(s) from incomplete removal of interstitial pore fluids in AGC-4-Cu5000 172 (FIG. 17), MAC-4-Cu5000 192 (FIG. 19) and MB-4-Cu5000 202 (FIG. 20) was seen in the d₁₀₀=5.7 Å reflection of Cu₂(OH)₃Cl (botallackite). Widths of reflections were only 3 to 4-times the scan step-interval (0.091-0.105°) at half-maximum intensity, suggesting a high-degree of crystallinity in the Cu₂(OH)₃Cl precipitate. By contrast, evidence for significant Cu-interaction with the fishbone substrate and formation of a poorly-crystalline new phase was seen in the scan of AP2-4-Cu5000 182 (FIG. 18) as a broad 9.6 Å-reflection with width 35-times the scan step-interval at half-maximum intensity.

Search and match fitting of reference pattern lines to experimental scans invoked tentative status to phase selections in Table 4.8.

TABLE 4.8
Summary Table of Phase Selections From Eva Search/Match

| Sample | Selected Mineral Phases | Chemical Formula |
|---|---|---|
| AGC-4(untreated) | Muscovite 2M₂ | KAl₂Si₃AlO₁₀(OH)₂ |
| | Beidellite | (Na,Ca)_{0.3}Al₂(Si,Al)₄O₁₀(OH)₂•xH₂O |
| | Loughlinite | Na₂Mg₃Si₆O₁₆•8H₂O |
| | Quartz | SiO₂ |
| | Cristobalite | SiO₂ |
| AGC-4-Cu5000 | Beidellite | (Na,Ca)_{0.3}Al₂(Si,Al)₄O₁₀(OH)₂•xH₂O |
| | Ammonium Hafnium Fluoride | (NH₄)₂HfF₆ |
| | Botallackite | Cu₂(OH)₃Cl |
| | Illite | K_{0.7}Al₂(Si,Al)₄O₁₀(OH)₂ |
| | Nontronite | (Na,Ca)_{0.3}Fe₂(Si,Al)₄O₁₀(OH)₂•xH₂O |
| AP2-4(untreated) | Hydroxylapatite | Ca_{9.61}(PO₄)_{5.77}(OH)_{2.29}((H₂O)_{1.01}H_{0.59}) |
| | Chlorellestadite | Ca5(P,Si,S)3O12(Cl,OH,F) |
| | Calcium Silicate | Ca3SiO5 |
| AP2-4-As5000 | Afwillite | Ca₃(SiO₃OH)₂•2H₂O |
| | Phaunouxite | Ca₃(AsO₄)₂•11H₂O |
| | Tooeleite | Fe₈(AsO₄)₆(OH)₆•5H₂O |
| AP2-4-Cu5000 | Hydroxylapatite | Ca₅(PO₄)₃(OH) |
| | Goldquarryite | CuCd₂Al₃(PO₄)₄F₂•12H₂O |
| | Ramsbeckite | Cu₁₅(SO₄)₄(OH)₂₂•6H₂O |
| | Pseudomalachite | Cu₅(PO₄)₂(OH)₄ |
| MAC-4(untreated) | Magnesioferrite | MgFe₂⁺³O₄ |
| | Magnetite | Fe⁺²Fe₂⁺³O₄ |
| | Maghemite | Fe₂O₃ |
| | Chromite | Fe⁺²Cr₂O₄ |
| | Iron | Fe |
| | Quartz | SiO₂ |
| MAC-4-As5000 | Makarochkinite | Ca₂Fe₄⁺²Fe⁺³TiSi₄BeAlO₂₀ |
| | Maghemite | Fe₂O₃ |
| | Sarmientite | Fe₂OH(AsO₄)(SO₄)•5H₂O |
| | Kankite | Fe⁺³AsO₄•3.5H₂O |
| MAC-4-Cu5000 | Botallackite | Cu₂(OH)₃Cl |
| | Atacamite | Cu₇⁺²Cl₄(OH)₁₀•H₂O |
| | Malachite | Cu₂⁺²(CO₃)(OH)₂ |
| | Maghemite | Fe₂O₃ |
| MB-4(untreated) | Muscovite 2M₁ | KAl_{2.9}Si_{3.1}O₁₀(OH)₂ |
| | Clinochlore1MIIb, ferroan | (Mg_{2.8}Fe_{1.7}Al_{1.2})(Si_{2.8}Al_{1.2})O₁₀(OH)₈ |
| | Beidellite | (Na,Ca)_{0.3}Al₂(Si,Al)₄O₁₀(OH)₂•xH₂O |
| | Quartz | SiO₂ |
| MB-4-As5000 | Quartz | SiO₂ |
| | Anorthite, ordered | CaAl₂Si₂O₈ |
| | Manganese Arsenate Hydroxide | Mn₇(AsO₃OH)₄₍AsO₄)₂ |
| | Unnamed | Ca—Cu—AsO₄—H₂O |
| | Lindackerite | Cu₅(AsO₄)₂(AsO₃OH)₂•9H₂O |
| MB-4-Cu5000 | Quartz | SiO₂ |
| | Botallackite | Cu₂(OH)₃Cl |
| | Owensite | (Ba,Pb)₆(Cu,Fe,Ni)₂₅S₂₇ |
| | Ramsbeckite | Cu₁₅(SO₄)₄(OH)₂₂•6H₂O |
| PR-4(untreated) | Carbonatefluorapatite | Ca₁₀(PO₄)5CO₃F_{1.5}(OH)_{0.5} |
| | Calcite | CaCO₃ |
| | Quartz | SiO₂ |

### 4.2.5 Ethylene Glycol Solvation of Organo-Clay (AGC-4) and Dredge (MB-4) Materials

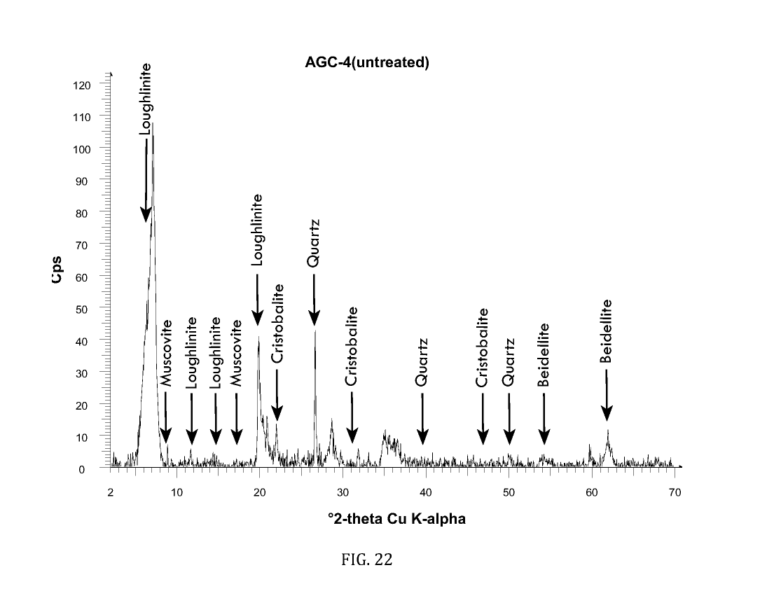

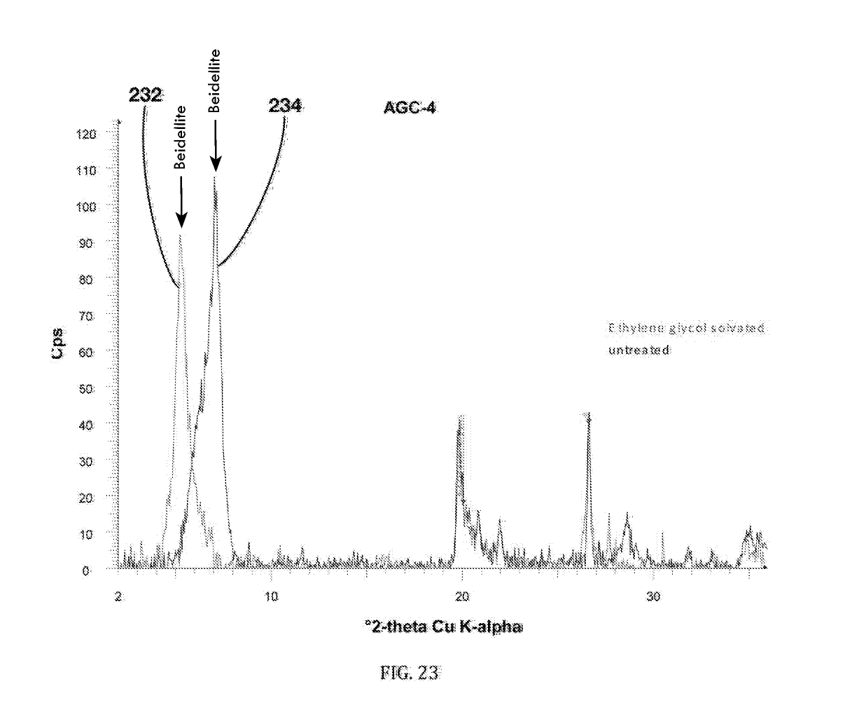

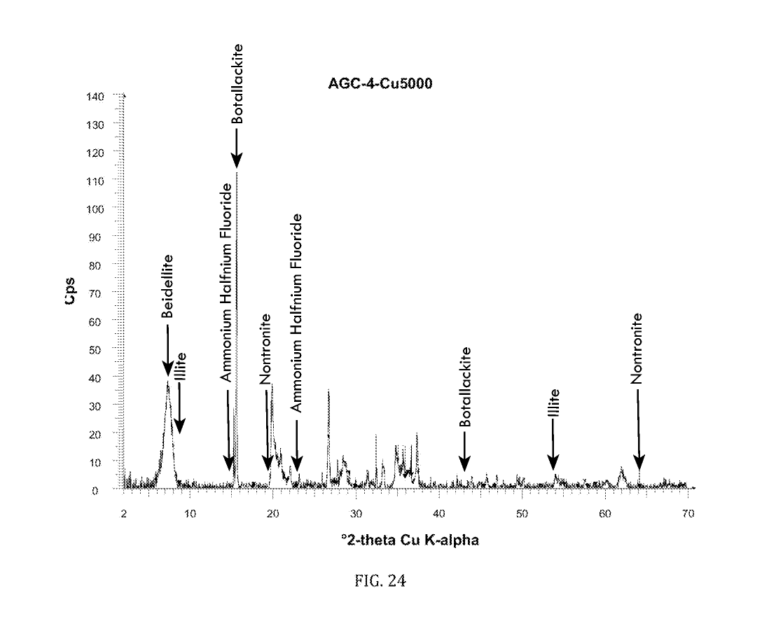

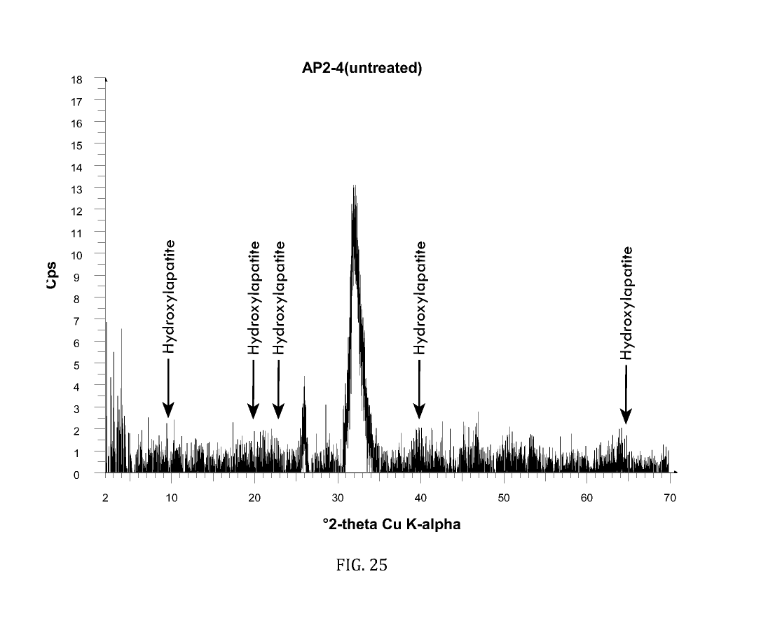

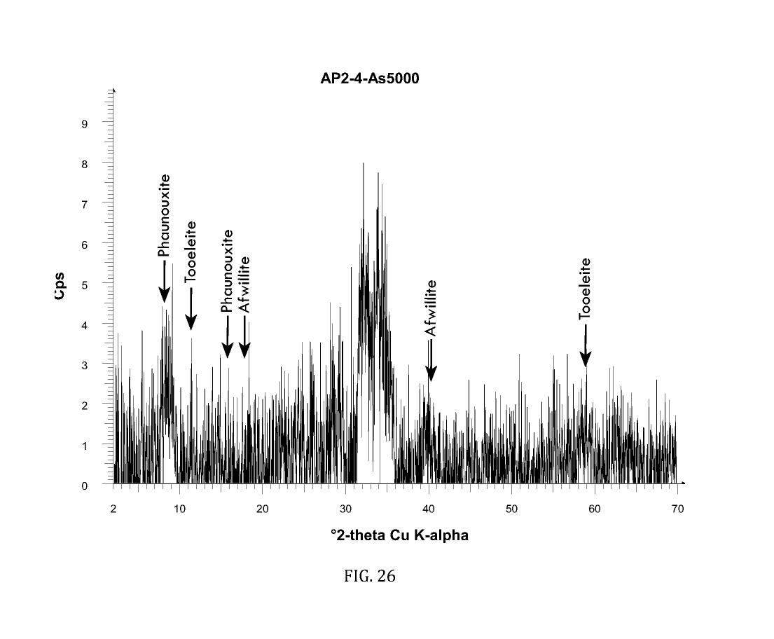

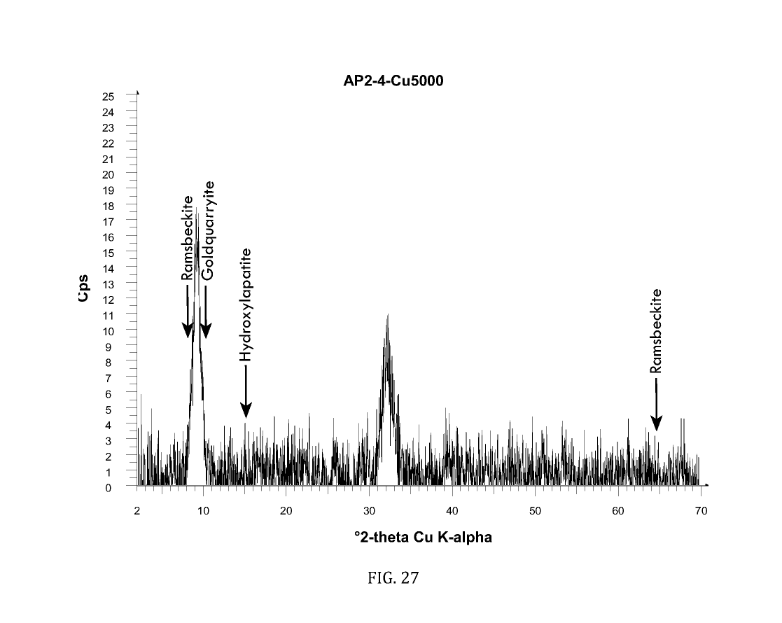

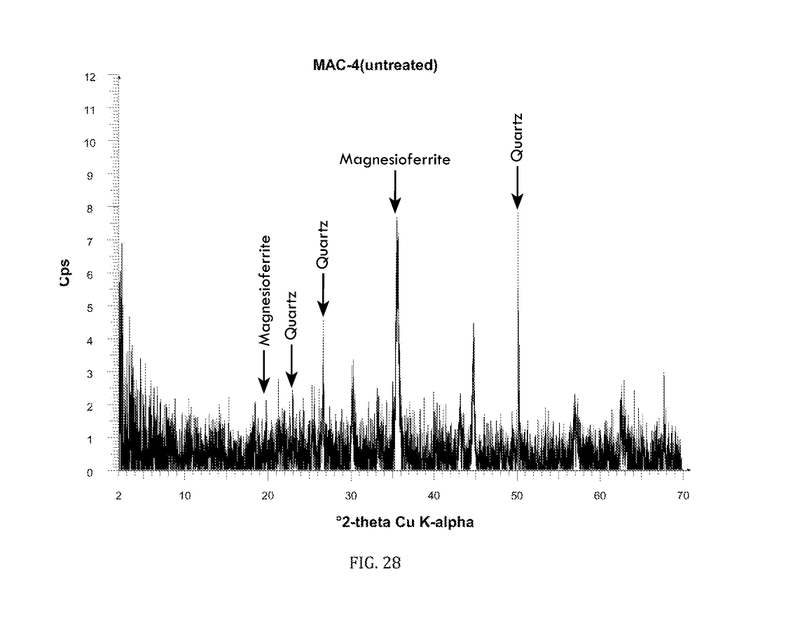

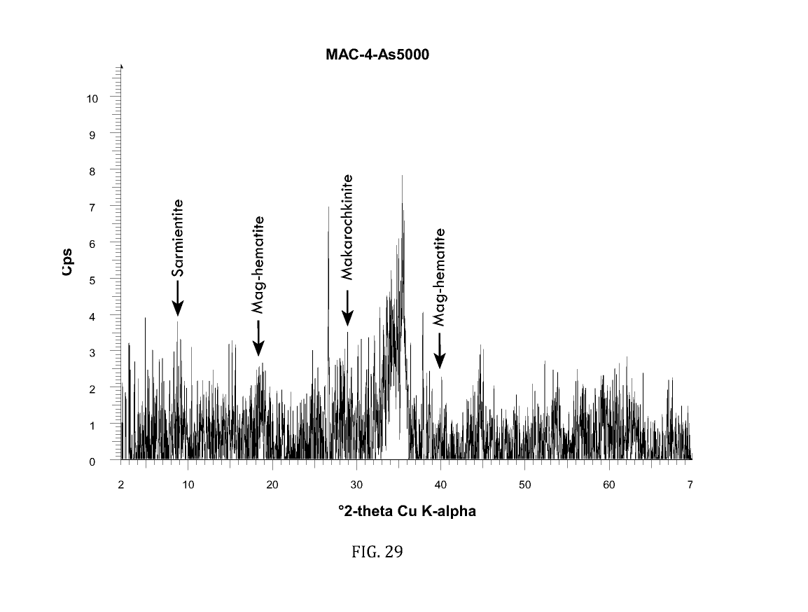

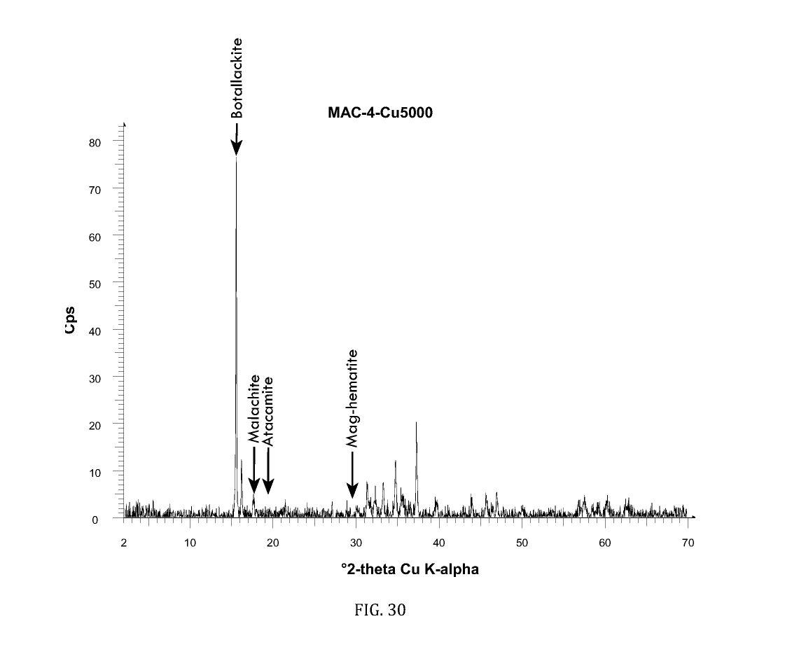

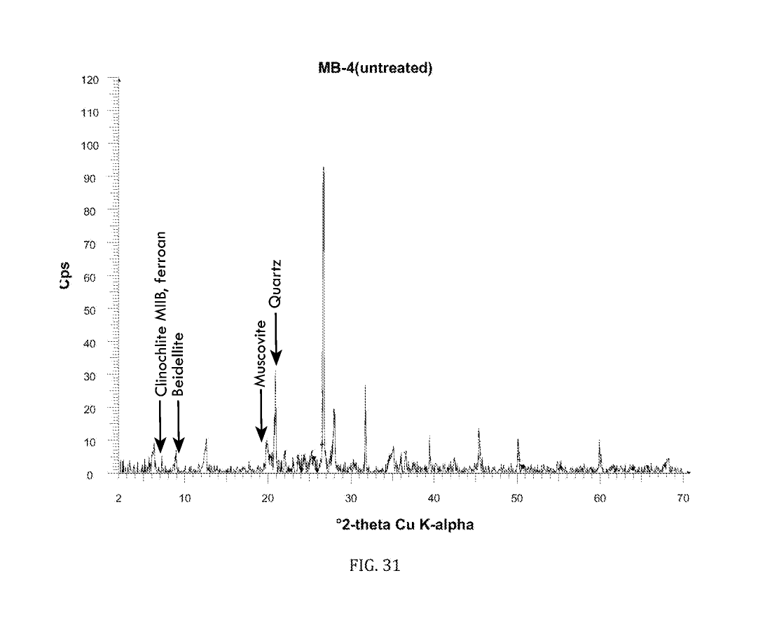

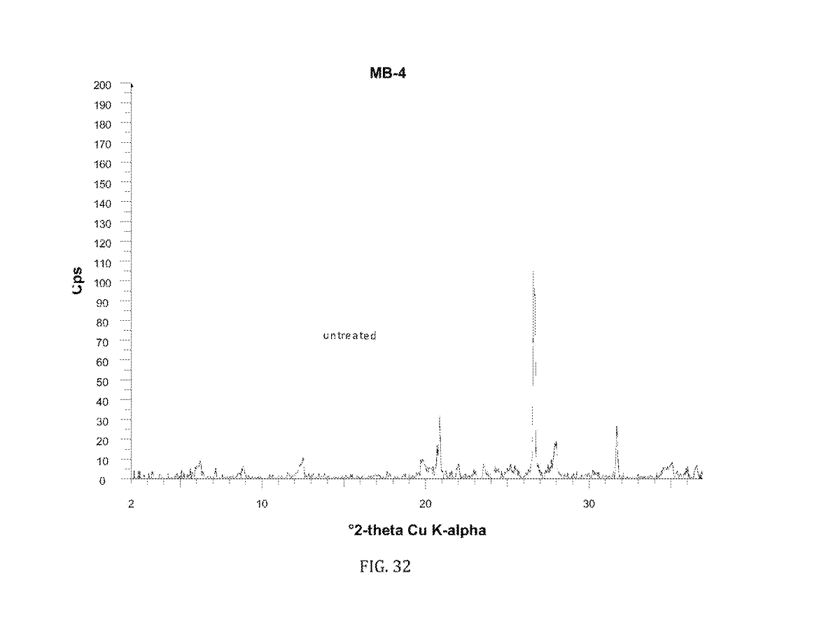

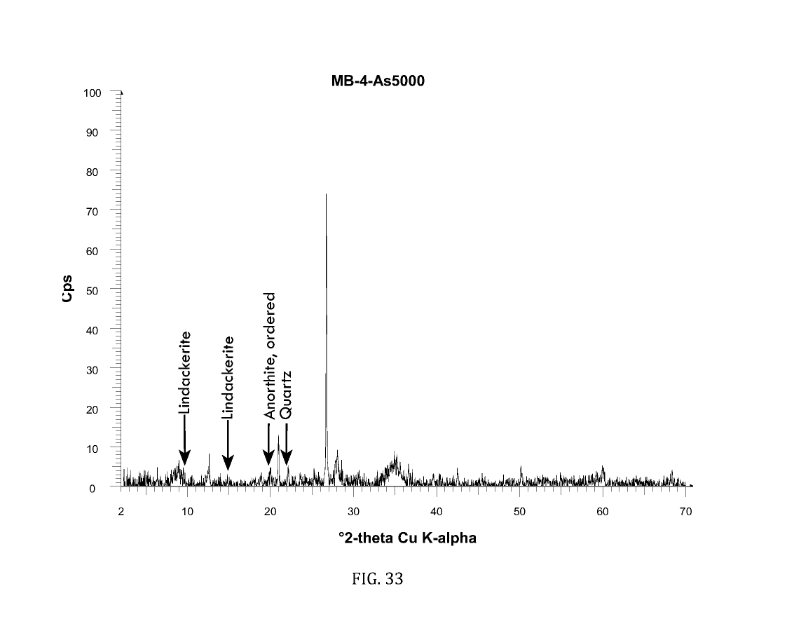

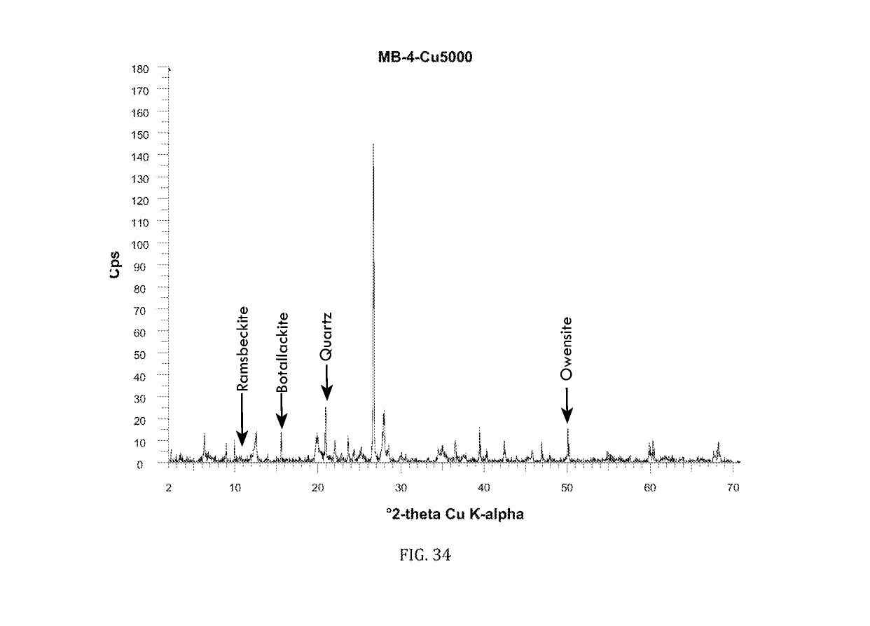

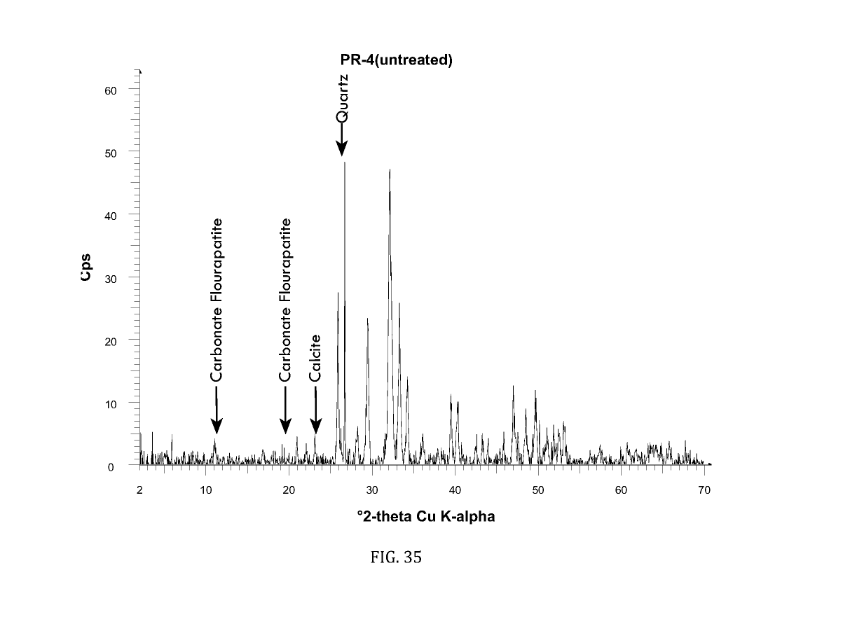

Reference patterns that were selected from the match-lists to describe the untreated phase compositions of the organo-clay (AGC-4, FIG. 22) and the dredge (MB-4, FIG. 31) materials comprised suites of mineral phases not uncommon to terrestrial sediments and soils. Clear evidence of an expandable 2:1 layer silicate component (beidellite) in the organo-clay (AGC-4, peaks 232 and 234 of FIG. 23) was seen as a low-angle shift in the 12.6 Å peak of the untreated AGC-4 to a 16.9 Å peak of the ethylene glycol solvated AGC-4. Ethylene glycol expansion of interlayer space between 2:1 expandable unit-layers was far less-well expressed in the dredge (MB-4, FIG. 32).

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. An anthropogenic sorbent material modified for sequestering and/or attenuating multiple chemical and/or biological pollutant species, both organic and inorganic, in an aqueous environment, the modified sorbent material comprising: a plurality of aluminosilicate particles, each particle having a particle size ranging from about 32×10⁻³ meters to about 3.9×10⁻⁶ meters based on the Krumbein phi scale wherein −5≦φ<8, wherein each particle further comprises a plurality of substantially interconnected pore spaces including micro-porous spaces, meso-porous spaces, and macro-porous spaces; one or more reactive microbiological species impregnated in some of the plurality of macro-porous pore spaces; and one or more functional moieties applied to at least a portion of the outer surfaces of at least a portion of the particles.

2. The anthropogenic sorbent material of claim 1 wherein each aluminosilicate particle has a particle size ranging from about 32×10⁻³ meters to about 2×10⁻³ meters based on the Krumbein phi scale wherein −5≦φ≦−1.

3. The anthropogenic sorbent material of claim 1 wherein each aluminosilicate particle has a particle size ranging from about 2×10⁻³ meters to about 3.9×10⁻⁶ meters based on the Krumbein phi scale wherein −1≦φ<8.

4. The anthropogenic sorbent material of claim 1 wherein the reactive chemical further comprises a member selected from the group consisting of an iron oxide, magnesium oxide, manganese dioxide, iron hydroxide, iron oxyhydroxide, and one or more combinations thereof.

5. A method of preparing an anthropogenic sorbent material modified for sequestering and/or attenuating multiple chemical and/or biological pollutant species, both organic and inorganic, in an aqueous environment, the method comprising the steps of: (a) dividing an aluminosilicate base into a plurality of aluminosilicate particles, each particle having a particle ranging from about 32×10⁻³ meters to about 3.9×10⁻⁶ meters based on the Krumbein phi scale wherein −5≦φ<8, wherein each particle further comprises a plurality of substantially interconnected pore spaces including micro-porous spaces, meso-porous spaces, and macro-porous spaces; (b) impregnating some of the plurality of macro-porous pore spaces with one or more reactive microbiological species; (c) applying one or more functional moieties to at least a portion of the outer surfaces of at least a portion of the particles.

6. A method of sequestering and/or attenuating multiple chemical and/or biological pollutant species, both organic and inorganic, in an aquatic ecosystem by capping at least a portion of a sedimentary basin of the aquatic ecosystem, the method comprising the steps of:
a) preparing an anthropogenic sorbent material comprising a plurality of aluminosilicate particles, each particle having a particle size ranging from about 32×10⁻³ meters to about 3.9×10⁻⁶ meters based on the Krumbein phi scale wherein −5≦φ<8, wherein each particle further comprises a plurality of substantially interconnected pore spaces including micro-porous spaces, meso-porous spaces, and macro-porous spaces;
b) applying the anthropogenic sorbent material to at least a portion of the sedimentary basin of the aquatic ecosystem.

7. The method of claim 7 wherein step a) further comprises the substep a)(1) of determining one or more conditions at the sedimentary basin including the type or types of pollutants to be treated in the aquatic ecosystem.

8. The method of claim 8 wherein step a) further comprises the substep a)2) of impregnating some of the plurality of pore spaces in the aluminosilicate particles with one or more microbiological species that react to digest and/or sequester at least some of the type or types of pollutants to be treated in the aquatic ecosystem.

9. The method of claim 8 wherein step a) further comprises the substep a)(2)′ of applying one or more functional moieties to at least a portion of the outer surfaces of at least a portion of the particles wherein the applied functional moieties are selected based on their reactivity to attenuate and/or sequester at least some of the type or types of pollutants to be treated in the aquatic ecosystem.

10. The method of claim 9 wherein step a) further comprises the substep a)(3) of applying one or more functional moieties to at least a portion of the outer surfaces of at least a portion of the particles wherein the applied functional moieties are selected based on their reactivity to attenuate and/or sequester at least some of the type or types of pollutants to be treated in the aquatic ecosystem.

11. The method of claim 8 wherein step b) further comprises the substeps of:
b)(1) mixing the particles of the anthropogenic sorbent material into an aqueous slurry;
b)(2) pumping the slurry to a location proximate a surface of the sedimentary basin to cover at least a portion of the surface of the sedimentary basin with the particles of the anthropogenic sorbent material.

12. The method of step 8 wherein step a)(1) further comprises determining the quantity or quantities of pollutants to be treated in the aquatic ecosystem.

13. The method of claim 8 wherein step b) further comprises applying the porous aluminosilicates in solid form.

14. The method of claim 13 wherein step b) further comprises applying the porous aluminosilicates in solid form to a location proximate a surface of the sedimentary basin to cover at least a portion of the surface of the sedimentary basin with the particles of the anthropogenic sorbent material.
